(19) United States
(12) Patent Application Publication
(10) Pub. No.: US 2020/0172667 A1
(43) Pub. Date: Jun. 4, 2020

(54) Cross-Linking Compositions for Forming Cross-Linked Organic Polymers, Organic Polymer Compositions, Methods of Forming the Same, and Molded Articles Produced Therefrom

(71) Applicant: Greene, Tweed Technologies, Inc., Wilmington, DE (US)

(72) Inventors: Sudipto Das, Somerville, NJ (US); Le Song, Chalfont, PA (US); Thomas Reger, Annapolis, MD (US)

(21) Appl. No.: 16/568,151

(22) Filed: Sep. 11, 2019

Related U.S. Application Data
(60) Provisional application No. 62/730,000, filed on Sep. 12, 2018.
(60) Provisional application No. 62/729,999, filed on Sep. 11, 2018.

(51) Int. Cl. C08G 65/38; C08K 5/09

(52) U.S. Cl. CPC C08G 65/38; C08G 2190/00; C08G 2650/20; C08K 5/09

(57) ABSTRACT

The present invention provides cross-linking compounds having structures as set forth herein for cross-linking organic polymers. Further, polymer compositions include a cross-linking compound and an organic polymer, and in some embodiments the composition further includes a cross-linking reaction additive for controlling the cross-linking reaction rate. In alternate embodiments, the present invention provides cross-linking compositions including a cross-linking compound and a cross-linking reaction additive capable of forming a reactive intermediate oligomer for cross-linking an organic polymer. Further provided are methods of cross-linking organic polymers, organic polymers formed thereby, and molded articles formed from the cross-linked organic polymers. Additionally, methods for forming high glass transition temperature elastomeric materials and methods for forming extrusion-resistant and creep-resistant materials are provided.

### CROSS-REFERENCE TO RELATED APPLICATIONS

This U.S. non-provisional patent application claims the benefit under 35 U.S.C. § 119(e) to U.S. provisional patent application No. 62/730,000, filed Sep. 12, 2019 and entitled, “Cross-Linking Compositions for Forming Cross-Linked Organic Polymers, Organic Polymer Compositions, Methods of Forming the Same,” and that further claims the benefit under 35 U.S.C. § 119(e) to U.S. provisional patent application No. 62/729,999, filed Sep. 11, 2019, and entitled, “Crosslinkable Aromatic Polymer Compositions for Use in Additive Manufacturing Processes and Methods for Forming the Same,” the entire disclosures of which are incorporated herein by reference.

### BACKGROUND OF THE INVENTION

### Field of the Invention

The present invention relates to cross-linking compositions and mixtures for forming cross-linked, high glass transition polymer systems. Further, the present invention relates to methods for making such polymers, and for controlling the cross-linking reaction rate of the cross-linking compounds in such compositions to form high glass transition temperature organic polymers which may be used, for example, to form seals and other wear-resistant components for use in downhole tool applications. The invention further relates to the use of such cross-linked organic polymer materials in high temperature end applications as elastomers where traditional and/or high purity elastomers lose performance due to polymer degradation or as a way to improve extrusion-resistance and creep-resistance of components in high temperature sealing applications.

### Description of Related Art

High glass transition temperature polymers, also referred to herein as “high T_{g}” polymers, have been useful for a number of high temperature applications. Modification of such high T_{g} organic polymers generally improves high temperature performance, strength and chemical resistance for use as parts and articles of manufacture necessary in extreme temperature environments as compared to unmodified organic polymers.

Cross-linking has been widely recognized as one way to modify high temperature polymeric materials. Several inventions have been aimed at improving the high temperature performance of organic polymers by using cross-linking within the polymers by cross-linking to itself, grafting cross-linking compounds to the polymer, or incorporating cross-linking compounds into the polymer, such as by blending.

U.S. Pat. No. 5,874,516, which is assigned to the Applicant of the present application and is incorporated herein by reference in relevant part, shows poly(arylene ether) polymers that are thermally stable, have low dielectric constants, low moisture absorption and low moisture outgassing. The polymers further have a structure that may cross-link to itself or can be cross-linked using a cross-linking agent.

U.S. Pat. No. 6,060,170, which is also assigned to the Applicant of the present application and is incorporated herein by reference in relevant part, describes the use of poly(arylene ether) polymer compositions having aromatic groups grafted on the polymer backbone, wherein the grafts allow for cross-linking of the polymers in a temperature range of from about 200° C. to about 450° C. This patent discloses dissolving the polymer in an appropriate solvent for grafting the cross-linking group. Such required process steps can sometimes make grafting difficult or not practical in certain types of polymers or in certain polymeric structures, including, e.g., polyetherether ketone (PEEK).

U.S. Pat. No. 8,502,401, which is also assigned to the Applicant of the present application and is incorporated herein by reference in relevant part, shows per(phenylethynyl) arene polymers that are grafted to a second polymer to provide a cross-linked polymeric network.

Previous attempts have also been made to control where cross-links form along high glass transition polymers to garner the desired mechanical properties and high temperature polymers. U.S. Pat. No. 5,658,994 of Applicant, incorporated herein by reference in relevant part, demonstrates the use of a poly(arylene ether) in low dielectric interlayers which may be cross-linked, for example, by cross-linking the polymer to itself, through exposure to temperatures of greater than about 350° C. or alternatively by using a cross-linking agent. In this patent and as mentioned in U.S. Pat. No. 5,874,516, cross-linking occurs at the ends of the polymer backbone using known end-capping agents, such as phenylethynyl, benzocyclobutene, ethynyl, and nitrile. The degree of cross-linking can be limited with the results of a lower glass transition temperature, reduced chemical resistance, and lesser tensile strength.

U.S. Pat. No. 9,006,353 of the Applicant of the present application, also incorporated herein by reference in relevant part, discloses a cross-linking compound, which is blended with an uncross-linked polymer to achieve a cross-linked organic polymer with a higher glass transition temperature for use in extreme conditions, such as in downhole tool applications.

While such cross-linking agents may be effective, there can be difficulty in controlling the rate and extent of cross-linking. Cross-linked organic polymers having aromatic groups in the backbone such as cross-linked polyarylene ether polymers, including cross-linked polyetherether ketone (PEEK), even when made using agents to control cross-linking as described herein are amorphous polymers that function well at high temperature (having a T_{g} above about 270° C.). The cross-linking provides enhanced chemical resistance to add to the high temperature properties of the base polymers. Cross-linking can be done using techniques as noted in the patents and patent application publications identified above and as described herein using Applicant's techniques. In molding, the controlled cross-linked polymers perform well at about 250° C. (or somewhat below the T_{g} of the materials). However, as molding temperatures rise, the reaction can accelerate such that full cure may be achieved in less than one minute. Cycle times for injection molded articles, such as tubes, rods or electrical connectors, however, are generally three to five minutes or longer. A full cure in less than a minute can impede the usefulness of conventional molding techniques, such as injection molding or extrusion, in forming molded parts.

Prior art attempts to retard or inhibit and moderate cross-linking reactions using compounds and their reactions are known. See, Vanderbilt Rubber Handbook, 13th ed., 1990, p. 281.

Further, Applicant has previously disclosed cross-linking compositions comprising cross-linking compounds and cross-linking reaction additives in U.S. Pat. No. 9,109,080, incorporated herein by reference in relevant part, to control and inhibit such reactions, and to improve the ability to process such polymers more easily using traditional molding techniques. However, some cross-linking compounds are more difficult and/or expensive to produce than others and require the use of extreme reaction conditions and harsh chemicals reagents. The cross-linking compounds therein are based on 9-fluorenone as the ketone unit, resulting in a relatively limited variety of cross-linking compounds that can be produced, wherein the cross-linking compounds have high melting points which may also limit the use of these cross-linking compounds to similar high temperature processing polymers.

Thus, it would be desirable to use a wider variety of cross-linking compounds that are at least as effective as Applicant's previously identified cross-linking compounds, wherein the cross-linking compounds can be more easily produced using less harsh chemical, mild reaction conditions, and with less expense. The cross-linking compounds may further allow for cross-linking polymers at a wider range of temperatures. Such new cross-linking compounds can be used in elastomeric applications as a substitute for elastomers such as fluorine-containing elastomers or used in high temperature end applications with respect to elastomer use.

Fluorine-containing elastomers, particularly perfluoroelastomers (FFKM) that include tetrafluoroethylene (TFE) and other fluorinated monomer units are known and employed in end applications where materials are required that exhibit excellent chemical resistance, solvent resistance and heat resistance. They are widely used for sealing and other products intended for use in harsh environments. Further, FFKMs are employed in end applications where a high degree of purity is required in addition to chemical resistance. As technology advances, the characteristics required even for such highly resistant compounds continue to be more rigorous. In the fields of aeronautics, downhole oil drilling, aerospace, semiconductor manufacturing, chemical manufacturing, and pharmaceutical manufacturing, sealing properties and other elastomeric properties continue to demand the ability to function under ever increasing harsh chemical environments that are also subject to high temperature environments of 300° C. or greater. The ability of such materials to withstand high temperature environments has become increasingly important.

While FFKMs provide excellent chemical and plasma resistance, in their unfilled state they typically have weaker mechanical properties. Thus, to achieve satisfactory compression set resistance and mechanical properties it is generally known in the art to include fillers or other reinforcing systems. It is a goal in the art to find ways to blend, modify, or fill such materials to make them useful in high temperature end applications and form molded parts that are capable of withstanding deformation and that can withstand ever increasing rigorous conditions. FFKM materials are typically prepared from perfluorinated monomers, including at least one perfluorinated cure site monomer. The monomers are polymerized to form a curable perfluorinated polymer having the cure sites thereon intended for cross-linking upon reaction with a curative or curing agent. Upon curing (cross-linking), the base polymer material becomes elastomeric in nature and exhibits elastomeric characteristics.

Typical fillers used in the semiconductor and other industries to enhance mechanical properties while trying to avoid diminishing chemical and/or plasma resistance include carbon black, silica, alumina, TFE-based fluoroplastics, barium sulfate, and other polymers and plastics. Blends of one or more FFKM curable polymers are sometimes made to achieve varying properties in attempts to improve such materials to meet the challenge of higher thermal, chemical, and plasma resistant property requirements for various end applications without sacrificing mechanical and sealing properties.

Use of fluoropolymeric fillers in such compositions can also sometimes contribute negatively to a relatively high compression set particularly in end applications at higher temperatures (e.g., >300° C.). Moldability and bondability can also be limited due to use of such fluoropolymeric fillers.

Various polymers have also been developed with unique cure systems to provide base FFKM compounds that have improved heat characteristics. One example of this is U.S. Pat. No. 6,855,774. The cross-links formed are described as contributing to increased heat resistance. U.S. Pat. No. 6,878,778 further teaches curatives that are described as contributing to resulting end materials having excellent chemical resistance and mechanical strength as well as heat resistance at high temperatures.

Blended FFKMs have also been developed to achieve unique properties. FFKMs such as those formed from U.S. Pat. Nos. 6,855,774 and 6,878,778 and other FFKMs as well have been blended. U.S. Pat. No. 8,367,776 describes compositions of such polymers as well as with one or more additional FFKM, wherein two of the FFKM compounds in the composition differ in terms of their perfluoroalkyl vinyl ether (PAVE) monomer content by about 5 to about 25 mole percent. Such blends are described as providing the ability to form compositions which can function well without the use of fluoroplastic fillers and are alternatives to and in some cases improvements over such filled materials. Such blends provide crack-resistance in the presence of harsh chemicals, and good thermal and plasma resistant properties.

U.S. Pat. No. 9,018,309 describes a blend of two or more FFKMs, one of which is a high-TFE content curable perfluoropolymer (as in U.S. Pat. No. 8,367,776) and one of which has a fluoroplastic incorporated in the matrix of a second curable perfluoropolymer. The combined materials provide improved high temperature properties. Such materials are the state of the art in high temperature elastomers and in demanding environments where chemical and/or plasma resistance is required.

While technology continues to strive to improve FFKM mechanical and compression set performance at high temperatures and increasingly harsh environments while retaining the beneficial chemical and/or plasma resistance of these materials due to their level of chemical purity and inertness, there remain performance issues which become of increasing focus in the art as end users continue to push operating conditions for such materials. As the temperature increases, FFKMs tend to thermally degrade limiting their useful range. While additives and various blending and/or curative modifications attempt to push the range higher, there are still limits.

Other polymers are well known for high temperature use but are not usually employed in all harsh environments where a combination of mechanical and elastomeric properties is desired. Aromatic polymers such as polyarylenes are known for having thermally stable backbones, but until recently were not generally suitable for elastomeric end applications. Attempts in the art have been made to use cross-linking of thermally stable polymers that are nonelastomeric at room temperature and then use them at a service temperature above their glass transition point.

WO 2011/071619 A1 discloses use of high temperature sealing elements to avoid degradation in downhole use that incorporate polyetherether ketone (PEEK) having N-Rx-N cross-linking groups linked to the PEEK backbone through C—N bonds.

Similarly, J. L. Hendrick et al., “Elastomeric Behavior of Cross-linked Poly(aryl ether ketone)s at Elevated Temperatures,” Polymer, Vol. 33, No. 23, pp. 5094-5097 (1992) PEEK which is cross-linked by maleic anhydride via oligomer end groups to form a PEEK that exhibits elastomeric properties above its T_{g}. However, also until recently such systems had not yet achieved the high temperature properties and/or hydrolytic stability desired to make the useful as an alternative to FFKMs and in high temperature end applications requiring the right balance of mechanical and elastomeric properties.

U. S. Patent Publication No. 2013/0012635 A1 discloses thermoplastic materials useful as shape memory material and articles in which the thermoplastic materials are formed from heating a shape memory polymer above its T_{g}, shaping the polymer and then fixing its shape into an article by cooling below the T_{g}. In use, such shaped articles are heated above their T_{g} and recover the first molded shape. The polymers suggested for use are those having thermal stability over 200° C. which may be cured in the presence or absence of oxygen. Cross-linkers such as sulfur, silica, quinone, peroxy compounds, metal peroxide, metal oxides and combinations of these cross-linkers can be used with the shape memory polymers for cross-linking.

Some of the prior art systems attempting such high temperature elastomeric end products with cross-linking use complex chemical synthesis to include specific functional groups on or in the polymer. This approach limits the ability to customize cross-link density as the polymer is fixed at the synthesis stage. Greater flexibility would allow the ability to customize the end materials for different uses.

FFKMs are not known as very strong elastomers. This is tolerated and filler systems are used to attempt to improve that drawback due to thermal stability, however, if the thermal stability could be improved and better mechanical properties achieved, a material would be available in the art to meet the ever increasing needs in high temperature and demanding environments. More products could be designed that are now not possible due to limitations in available materials.

U.S. Pat. No. 9,109,075 of the Applicant of the present application, also incorporated herein by reference in relevant part, discloses cross-linked organic polymers for high temperature end applications. Although cross-linked organic polymers for high temperature end applications are provided, the cross-linking compounds used in such cross-linked organic polymers can be difficult and/or expensive to produce. It would be desirable to provide a wider variety of cross-linking compounds for use in producing polymers for high temperature end applications, wherein the cross-linking compounds are less expensive and more easily produced.

Sealing components and other wear resistant materials can be used in very rigorous and demanding environments. Their wear and mechanical properties are very critical to their applicability and useful life. For example, sealing components are typically formed of elastomeric materials that are situated in a gland. In one application, an annular seal may fit within a gland and be installed to seal a gap between surfaces, e.g., a seal may be installed around a shaft that fits within a bore and the bore can be configured to have a gland for receiving the seal. In many instances, the seal is not installed alone and is part of a seal assembly. Such assemblies may include back-up rings and other components. Seals and seal assemblies are usually constructed to support the primary sealing element, generally formed of an elastomeric material, to prevent extrusion of that material into the gland and into the space or gap between the sealing surfaces.

When temperatures of use become high, pure elastomeric seals may not be able to provide sufficient sealing force to prevent leakage and/or may extrude into the gap between sealing surfaces, e.g., a shaft and a seal. Under such conditions, thermoplastic materials with higher shear strengths may be used to isolate the soft elastomer component from the gap between the sealing surfaces to assist in resisting extrusion. Combination of harder and softer materials are sometimes also used so that softer materials (such as, for example, polytetrafluoroethylene (PTFE) or other fluoropolymeric materials) are prevented from extruding into the gap by stiffer thermoplastic antiextrusion components. Such materials are used in unidirectional and bidirectional sealing assemblies.

Materials that have been used as antiextrusion components include polyetherether ketone (PEEK) and similar polyketones. Continuous use temperatures for such materials range from about 240° C. to about 260° C., including for commercial polyarylketones, such as Victrex® polyarylenes.

In use, at elevated temperatures, polyketones are well above their glass transition temperatures. For example, PEEK is semicrystalline and has a T_{g} of 143° C. Other polyketones such as Victrex® PEK and PEKEKK have respective glass transition temperatures of 152° C. and 162° C.

As semicrystalline materials are used above their glass transition temperatures, they tend to demonstrate lower mechanical properties in service and there is a corresponding drop in performance. With reference to FIGS. 2 and 3, this effect can be seen as PEEK rings are loaded below and above their glass transition temperatures, respectively, and significant differences in extrusion resistance can be seen. FIG. 3 shows a 60% increase in extrusion at a pressure that is 50% lower for the same loading period.

Such extrusion issues are also problematic in the area of electrical connectors. Such connectors are used to relay electrical signals from sensors to electronics in downhole oil exploration tools. They function also as bulkhead seals and are the last line of defense against destruction of electronics in an oil exploration tool when the tool suffers a catastrophic failure. Such seals must be able to withstand high pressure for extended periods of time at elevated temperature. Unfortunately, many downhole oilfield products are used at or above the T_{g} of various commercial polyketones, so that severe extrusion can take place. Often such extrusion results in failure of the part as a seal, allowing either moisture to leak through the seal or for the part to deform so it no longer performs properly mechanically. An example of this behavior can be seen in FIG. 4, which demonstrates extrusion on an electrical connector.

Attempts to enhance the properties of PEEK have been attempted. As previously discussed, cross-linking has been widely recognized as one way to modify high temperature polymeric materials. Several inventions have been aimed at improving the high temperature performance of organic polymers by using cross-linking within the polymers by cross-linking to itself, grafting cross-linking compounds to the polymer, or by incorporating cross-linking compounds into the polymer such as by blending.

U.S. Pat. No. 5,173,542 discloses use of bistriazene compounds for cross-linking polyimides, polyarylene ketones, polyarylether sulfones, polyquinolines, polyquinoxalines, and non-aromatic fluoropolymers. The resulting cross-linked polymers are useful as interlayer insulators in multilayer integrated circuits. The patent discusses difficulties in the art encountered includes controlling the cross-linking process in aromatic polymers to enhance properties. It proposes a bistriazene cross-linking structure and method to enhance chemical resistance and reduce crazing so that useful interlayer materials may be formed.

Other attempts to cross-link polymers to enhance high temperature properties have encountered difficulty with respect to thermal stability of the polymer. Other issues arise in terms of control of the rate and extent of cross-linking.

U.S. Pat. No. 5,874,516, which is assigned to the Applicant of the present application and is incorporated herein by reference in relevant part, shows polyarylene ether polymers that are thermally stable, have low dielectric constants, low moisture absorption and low moisture outgassing. The polymers further have a structure that may cross-link to itself or can be cross-linked using a cross-linking agent.

A further patent, U.S. Pat. No. 5,658,994 discusses a polyarylene ether polymer in which the polymer may be cross-linked, e.g., by cross-linking itself through exposure to temperatures of greater than about 350° C. or by use of a cross-linking agent. The patent also describes end-capping the polymer using known end-capping agents, such as phenylethynyl, benzocyclobutene, ethynyl, and nitrile. Limited cross-linking is present at the end of the chain such that relevant properties, i.e., the glass transition temperature, the chemical resistance and the mechanical properties, are not enhanced sufficiently for all high temperature applications,

Further developments in improving polyarylene ether polymer properties are described in U.S. Pat. No. 8,502,401, which describes use of per(phenylethynyl)arenes as additives for polyarylene ethers, polyimides, polyureas, polyurethanes and polysulfones. The patent discusses formation of a semi-interpenetrating polymer network between two polymers to improve properties.

U.S. Pat. No. 9,006,353 of Applicant describes a composition having a cross-linking compound of the structure:

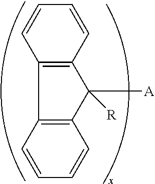

wherein R is OH, NH₂, halide, ester, amine, ether or amide, and x is 2 to 6 and A is an arene moiety having a molecular weight of less than about 10,000 g/mol. When reacted with an aromatic polymer, such as a polyarylene ketone, it forms a thermally stable, cross-linked polymer. This technology provided for the cross-linking of polymers that were difficult or to cross-link, and which are thermally stable up to temperatures greater than 260° C. and even greater than 400° C. or more, depending on the polymer so modified, i.e., polysulfones, polyimides, polyamides, polyetherketones and other polyarylene ketones, polyureas, polyurethanes, polyphthalamides, polyamide-imides, aramids, and polybenzimidazoles.

While polyimides and polyamide-imide copolymers have higher glass transition temperatures of about 260° C. or more, they tend to not be useful in strong acids, bases or aqueous environments, as they suffer more easily from chemical attack. As a result, while their operating temperatures are more attractive, their chemical resistance properties limit their usefulness in sealing applications where the fluid medium is water based or otherwise harmful to the material. For example, testing of polyimide by Applicant has shown about an 80% loss in properties after aging at 200° C. for three days in steam, using ASTM-D790 to test the flexural modulus.

Fully aromatic polysulfones such as polyether sulfone (PES) and polyphenyl sulfone (PPSU) may be used in such end applications, but their amorphous nature creates issues in that they are vulnerable to stress cracking in the presence of strong acids and bases. Due to the possibility of the amorphous polymers flowing at temperatures near their glass transition temperature over time, continuous use temperatures are typically set about 30° C. to 40° C. below the glass transition temperature. Thus, for continuous use for a polysulfone (PSU), the temperature is recommended to be set at 180° C. when the glass transition temperature is about 220° C.

Other problems encountered in more demanding end uses exposed to harsh chemicals, water and/or steam, include problems associated with a plasticizer effect caused when the polymer absorbs the chemical which can enhance motion of molecular chains and create a depression of the glass transition temperature from its normal state in the unswollen polymer.

A further issue is associated with creep. When polymers operate above their glass transition temperature, creep is a limiting factor for seal components which can deform under harsh conditions. Thus, to improve mechanical properties, prevent creep and resist extrusion, most high temperature polymers in use are filled for use as backup rings or molded components. The downside of use of fillers is that it typically drops the ductility tremendously. For example, unfilled PEEK has a tensile elongation of about 40%, whereas 30% carbon-filled PEEK has a tensile elongation at break of only 1.7%. Thus the material becomes more brittle from the strengthening filler, and the brittleness can result in part cracking under prolonged loadings. The use of fillers also causes a differential coefficient of thermal expansion in the mold versus the transverse direction of the molded parts. This can also cause significant molded-in stress. The end result is cracking over time due to creep rupture, even when a part is not under a significant load.

U.S. Pat. No. 9,127,138 and U.S. Patent Application Publication No. US2015/0544688A1 which are assigned to the Applicant and are incorporated herein by reference in relevant part, relate to sealing components formed from an organic aromatic polymer and a cross-linking compound to provide sealing components that are extrusion and creep resistant. However, the cross-linking compounds therein can be difficult and expensive to produce. It would be desirable to form extrusion-resistant and creep-resistant sealing components using cross-linking compounds that are more easily produced under mild reaction conditions and by use of less harsh reagents, such that the cross-linking compounds can be produced with less expense.

Thus, while Applicants have previously developed new ways to utilize cross-linked aromatic polymers, there is a need in the art for alternative cross-linking compounds that perform at least as well as those in Applicant's prior patents but present easy to use and more cost effective alternatives. Such alternate cross-linking compounds must still effectively operate as sealing components, seal connectors and similar parts. The cross-linking compounds must be useful for operation at high service temperatures associated with oilfield and other harsh conditions and industrial uses, while still maintaining good mechanical performance, resisting extrusion of the seal or connector material into a gap between two surfaces to be sealed or along the pin, and resisting creep when in use without becoming brittle and significantly losing its ductility.

### BRIEF SUMMARY OF THE INVENTION

The present invention provides a cross-linking composition for cross-linking an organic polymer, comprising a cross-linking compound having a structure according to one or more of the following formulas:

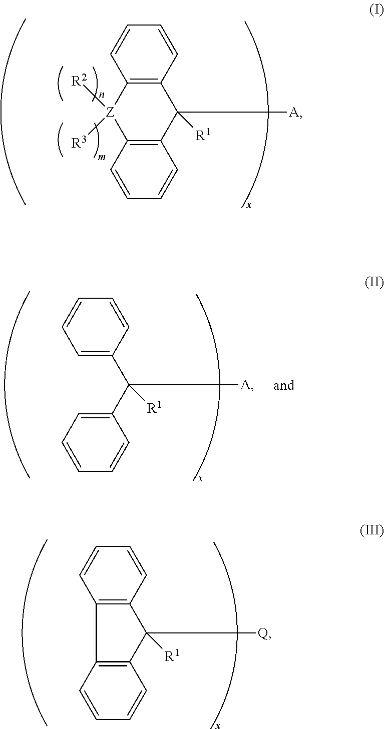

wherein Q is a bond, wherein A is Q, an alkyl, an aryl, or an arene moiety having a molecular weight less than about 10,000 g/mol, wherein each of R¹, R², and R³ has a molecular weight less than about 10,000 g/mol, wherein R¹, R², and R³ are the same or different and selected from the group consisting of hydrogen, hydroxyl (—OH), amine (—NH₂), halide, ether, ester, amide, aryl, arene, or a branched or straight chain, saturated or unsaturated alkyl group of one to about six carbon atoms, wherein m is from 0 to 2, n is from 0 to 2, and m+n is greater than or equal to zero and less than or equal to two, wherein Z is selected from the group of oxygen, sulfur, nitrogen, and a branched or straight chain, saturated or unsaturated alkyl group of one to about six carbon atoms, and wherein x is about 1.0 to about 6.0.

In some embodiments, the cross-linking composition may comprise a blend of one or more cross-linking compounds selected from formulas (I), (II), and (III). Further, in other embodiments, the cross-linking composition may include at least one cross-linking compound selected from formulas (I), (II), and (III), and also including at least one additional cross-linking compound, such as a cross-linking compound of the type disclosed in U.S. Pat. No. 9,006,353. While blends of one or more cross-linking compound may be used, it is preferred that a single cross-linking compound is selected.

The cross-linking compound in the composition as noted above may have a structure according to formula (I) and selected from the group consisting of:

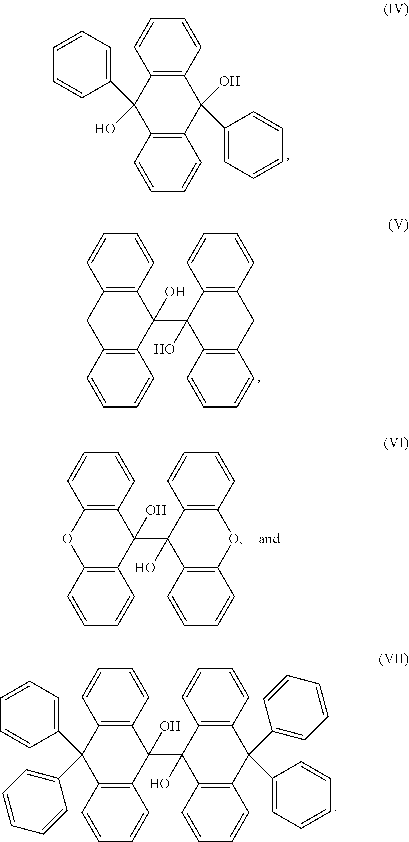

The cross-linking compound in the composition as noted above may have a structure according to formula (II) and is selected from the group consisting of:

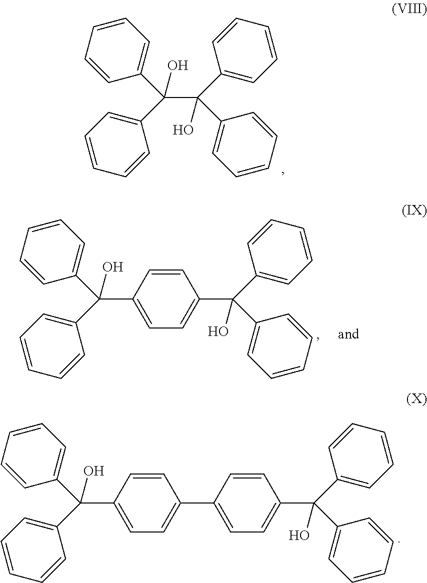 [SMILES: OC(c1ccccc1)(c1ccccc1)C(O)(c1ccccc1)c1ccccc1 ; OC(c1ccccc1)(c1ccccc1)c1ccc(C(O)(c2ccccc2)c2ccccc2)cc1 ; OC(c1ccccc1)(c1ccccc1)c1ccc(-c2ccc(C(O)(c3ccccc3)c3ccccc3)cc2)cc1]

The cross linking compound in the composition as noted above may also have a structure according to formula (III) and also as follows:

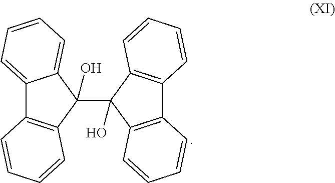 [SMILES: OC1(C2(O)c3ccccc3-c3ccccc32)c2ccccc2-c2ccccc21]

The arene, alkyl, or aryl moiety A of the cross-linking compounds according to formula (I) or (II) as noted above preferably has a molecular weight of about 1,000 g/mol to about 9,000 g/mol, and more preferably about 2,000 g/mol to about 7,000 g/mol.

In another embodiment, the invention includes an organic polymer composition for use in forming a cross-linked organic polymer, comprising an organic polymer and at least one cross-linking compound having a structure selected from formula (I), formula (II), and formula (III) as shown above.

The organic polymer is preferably a polymer selected from poly(arylene ether)s, polysulfones, polyethersulfones, polyimides, polyamides, polyureas, polyurethanes, polyphthalamides, polyamide-imides, poly(benzimidazole)s, and polyaramids.

The organic polymer may also be a polymer in one embodiment herein that is a poly(arylene ether) including polymer repeating units along its backbone having the structure according to formula (XIII):

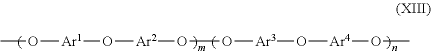

wherein Ar¹, Ar², Ar³ and Ar⁴ are identical or different aryl radicals, m=0 to 1.0, and n=1-m.

In a further preferred embodiment, the organic polymer is a polymer having an aromatic group in the backbone, preferably a poly(arylene ether), m is 1 and n is 0 and the polymer has repeating units along its backbone having the structure of formula (XIV):

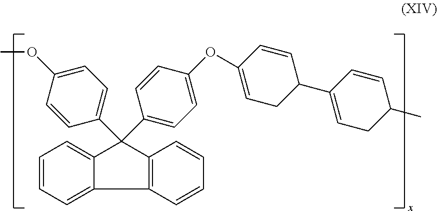

The organic polymer composition may further comprise one or more additives. Preferably, the additive(s) is/are selected from one or more of continuous or discontinuous, long or short, reinforcing fibers selected from one or more of carbon fibers, glass fibers, woven glass fibers, woven carbon fibers, aramid fibers, boron fibers, polytetrafluorethylene (PTFE) fibers, ceramic fibers, polyamide fibers, and/or one or more filler(s) selected from carbon black, silicate, fiberglass, calcium sulfate, boron, ceramic, polyamide, asbestos, fluorographite, aluminum hydroxide, barium sulfate, calcium carbonate, magnesium carbonate, silica, alumina, aluminum nitride, borax (sodium borate), activated carbon, pearlite, zinc terephthalate, graphite, talc, mica, silicon carbide whiskers or platelets, nanofillers, molybdenum disulfide, fluoropolymer fillers, carbon nanotubes and fullerene tubes.

The additive preferably includes a reinforcing fiber which is a continuous or discontinuous, long or short fiber, that is carbon fiber, polytetrafluoroethylene (PTFE) fiber, and/or glass fiber. Most preferably, the additive is a reinforcing fiber and is a continuous long fiber. The organic polymer composition in preferred embodiments comprises about 0.5% to about 65% by weight of additive(s) in the composition and more preferably about 5.0% to about 40% by weight of additive(s) in the composition. The organic polymer composition may further comprise one or more of stabilizers, flame retardants, pigments, colorants, plasticizers, surfactants, and/or dispersants.

In another embodiment according to the present invention, the cross-linking composition comprises a cross-linking compound having a structure as described above and a cross-linking reaction additive. The cross-linking reaction additive is selected from an organic acid and/or an acetate compound and is capable of forming a reactive intermediate in the form of an oligomer, which reactive intermediate oligomer is capable of cross-linking an organic polymer. The cross-linking reaction additive may be an organic acid, such as glacial acetic acid, formic acid, and/or benzoic acid.

The cross-linking reaction additive may be an acetate compound that has a structure according to formula (XII):

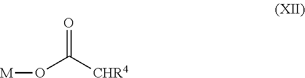

wherein M is a Group I or a Group II metal; and R⁴ is an alkyl, aryl, or aralkyl group, wherein the alkyl group is a hydrocarbon group of 1 to about 30 carbon atoms, preferably about 1 to about 15 carbon atoms having 0 to about 10 ester or ether groups along or in the chain of the hydrocarbon group, preferably about 0 to about 5 ester or ether groups, wherein R⁴ may have 0 to about 10, preferably about 0 to about 5, functional groups that may be one or more of sulfate, phosphate, hydroxyl, carbonyl, ester, halide, mercapto or potassium. More preferably, the acetate compound may be lithium acetate hydrate, sodium acetate and/or potassium acetate, and salts and derivatives thereof.

The weight percentage ratio of the cross-linking compound to the cross-linking reaction additive may be about 10:1 to about 10,000:1, and more preferably about 20:1 to about 1000:1.

In another embodiment, the invention includes an organic polymer composition for use in forming a cross-linked organic polymer, comprising a cross-linking compound having a structure selected from formula (I), formula (II), and formula (III) as described above; a cross-linking reaction additive selected from an organic acid and/or an acetate compound; and at least one organic polymer, wherein the cross-linking reaction additive is capable of reacting with the cross-linking compound to form a reactive intermediate in the form of an oligomer, which reactive intermediate oligomer is capable of cross-linking the organic polymer.

In a further embodiment, the invention includes an organic polymer composition for use in forming a cross-linked organic polymer, comprising an organic polymer and a reactive cross-linking oligomer which is a reaction product of a cross-linking compound having a structure selected from the group of formula (I), formula (II), and formula (III) as described above and a cross-linking reaction additive selected from an organic acid and/or an acetate compound. Preferably, the weight percentage ratio of the organic polymer to the combined weight of the cross-linking compound and the cross-linking reaction additive is about 1:1 to about 100:1.

The organic polymer is selected from any of the organic polymers as discussed above. Further, when the organic polymer is a polyarylene ether it may have repeating units according to the structure of formula (XIII), and may have a structure of formula (XIV).

The cross-linking composition may further comprise at least one additive as discussed above, wherein the composition comprises 0.5% to about 65% by weight of the at least one additive. The cross-linking composition may further comprises one or more of a stabilizer, a flame retardant, a pigment, a plasticizer, a surfactant, and a dispersant.

The cross-linking composition may be used to form a molded article. The molded article is molded using extrusion, injection molding, blow molding, blown film molding, compression molding, or injection/compression molding. The article of manufactured is selected from acid-resistant coatings, chemical-casted films, extruded films, solvent-casted films, blown films, encapsulated products, insulation, packaging, composite cells, connectors, and sealing assemblies in the shape of O-rings, V-rings, U-cups, gaskets, bearings, valve seats, adapters, wiper rings, chevron back-up rings, and tubing.

A method is also provided herein for controlling the cross-linking reaction rate of a cross-linking compound of the type described herein for use in cross-linking an organic polymer. The method comprises providing a cross-linking composition comprising a cross-linking compound and a cross-linking reaction additive selected from an organic acid and/or an acetate compound, wherein the cross-linking compound has a structure selected from the group consisting of formula (I), formula (II), and formula (III) as shown above, and heating the cross-linking composition such that oligomerization of the cross-linking compound occurs. In some embodiments, the cross-linking composition comprises one or more additional cross-linking compounds.

In one embodiment, the method further comprises heating the cross-linking composition before heat molding. In an alternative embodiment, the method further comprises heating the cross-linking composition during heat molding.

The cross-linking compound used in the method for controlling the cross-linking reaction rate may have any of the various structures as noted above. In one embodiment, the cross-linking reaction additive is an organic acid selected from glacial acetic acid, formic acid, and/or benzoic acid, and/or an acetate compound selected from lithium acetate hydrate, sodium acetate, and/or potassium acetate, and salts and derivatives thereof.

In one embodiment, the method for controlling the cross-linking reaction rate further comprises combining the cross-linking compound and the cross-linking reaction additive in a solvent and reacting the cross-linking compound and the cross-linking reaction additive to form a reactive oligomerized cross-linking compound. In an alternative embodiment, the method for controlling the cross-linking reaction rate further comprises combining the cross-linking compound and the cross-linking reaction additive in solid form.

The method for controlling the cross-linking reaction rate may comprise adding the reactive oligomerized cross-linking compound to an organic polymer to form a cross-linkable composition, and cross-linking the organic polymer composition to form a cross-linked organic polymer.

In the method for controlling the cross-linking reaction rate, the organic polymer can be any of the organic polymers as discussed above. The organic polymer may be a polyarylene ether including polymer repeating units according to the structure of formula (XIII).

As observed by Applicant in U.S. Pat. No. 9,109,080, incorporated herein by reference in relevant part, as viscosity increases in aromatic group-containing organic polymers, the degree of inhibition which can be achieved from using such cross-linking reaction additives for rate control may not always be sufficient such that in some embodiments, additional modification is desirable to improve end effects by reducing and/or controlling the curing and cross-linking rate. While U.S. Pat. No. 9,109,080 identified debrominated organic polymers for cross-linking, this patent provided limited cross-linking compounds, wherein such compounds may be difficult and/or expensive to produce.

The present invention provides debrominated organic polymers for cross-linking, particularly useful for those organic polymers having an aromatic group in the backbone and/or that are in the category of high glass transition temperature polymers, as well as compositions including such dehalogenated organic polymers and methods for preparing and cross-linking the same using the cross-linking compounds of formula (I), formula (II), and formula (III), discussed above. The resulting articles are formed using controlled cross-linking reaction rates enabling use of traditional molding techniques during cross-linking of such polymers due to the enhanced processability of the dehalogenated organic polymers. As previously observed by the Applicant, this allows for creation of a variety of unique and readily moldable cross-linked organic polymer articles of manufacture providing the beneficial properties of such materials, including chemical resistance, high-temperature and high-pressure performance and strength for a variety of end applications.

Included herein is an organic polymer composition for use in forming a cross-linked aromatic polymer, comprising a dehalogenated organic polymer and at least one cross-linking compound having a structure selected from the group of formula (I), formula (II), and formula (III) and described in detail above. The dehalogenated organic polymer is formed by a process comprising reacting an organic polymer having at least one halogen-containing reactive group with an alkali metal compound to break a bond between the organic polymer having the at least one halogen-containing reactive group and a halogen atom in the at least one halogen containing reactive group to form an intermediate.

In one embodiment, the dehalogenated organic polymer is a debrominated organic polymer, wherein the organic polymer may be any of the types of polymers discussed above, and may be a polyarylene ether having polymer repeating units according to formula (XIII). Further, the organic polymer composition may further comprise a cross-linking reaction additive selected from an organic acid and/or an acetate compound, wherein the cross-linking reaction additive is capable of reacting with the cross-linking compound to form a reactive intermediate in the form of an oligomer, which reactive intermediate oligomer is capable of cross-linking the dehalogenated organic polymer.

The dehalogenated organic polymer can be formed by reacting an organic polymer having at least one halogen-containing reactive group with an alkali metal compound to break the bond between the organic polymer having the at least one halogen-containing reactive group and the halogen atom in the at least one halogen-containing reactive group to form an intermediate having a carbocation as described in U.S. Pat. No. 9,109,080, assigned to Applicant and incorporated herein in relevant part. The intermediate having the carbocation is reacted with acetic acid to form the debrominated organic polymer. In one embodiment, the halogen-containing reactive group is a bromine-containing reactive group.

The alkali metal compound useful in such a dehalogenation reaction is preferably one having the structure R⁵-M′, wherein M′ is an alkali metal and R⁵ is H or a branched or straight chain organic group selected from alkyl, alkenyl, aryl and aralkyl groups of from 1 to about 30 carbon atoms having from 0 to about 10 ester or ether groups along or in a chain or structure of the group, and wherein R⁵ may be substituted or unsubstituted.

The alkali metal compound may in one preferred embodiment herein be t-butyllithium. The organic polymer having at least one halogen-containing end group, such as a bromine-containing reactive group, is preferably reacted with the alkali metal compound in a solvent, and the organic polymer having at least one halogen-containing end group is also preferably dried prior to reacting in the solvent. The reaction occurs at low temperatures until a majority of halogen atoms are removed from the organic polymer.

The organic polymer composition can be used to form a molded article. The molded article may be formed using extrusion, injection molding, blow molding, blown film molding, compression molding, or injection/compression molding. The article of manufacture being selected from acid-resistant coatings; chemical-casted films; extruded films; solvent-casted films; blown films; encapsulated products; insulation; packaging; composite cells; connectors; sealing assemblies; including O-rings, V-rings, U-cups, gaskets; bearings; valve seats; adapters; wiper rings; chevron back-up rings; and tubing.

After dehalogenation of the organic polymer, the polymer can be introduced into a cross-linking reaction to provide enhanced performance to such a reaction. Thus, the present invention includes a method of controlling the cross-linking reaction rate of an organic polymer having at least one halogen-containing reactive group during a cross-linking reaction, preferably organic polymers having an aromatic group in the backbone chain of the polymer. The method comprises: (a) reacting the organic polymer having at least one halogen-containing reactive group with an alkali metal compound to break the bond between the organic polymer having the at least one halogen-containing reactive group and the halogen atom in the at least one halogen-containing reactive group and thereby forming an intermediate having a carbocation; (b) reacting the intermediate having the carbocation with acetic acid to form a dehalogenated organic polymer; and (c) cross-linking the dehalogenated organic polymer using a cross-linking reaction utilizing a cross-linking compound according to formula (I), (II), or (III) as described herein.

The at least one halogen-containing reactive group is generally a terminal group and the organic polymer may be any of those noted above, such as poly(arylene ether)s, polysulfones, polyethersulfones, polyimides, polyamides, polyureas, polyurethanes, polyphthalamides, polyamide-imides, poly(benzimidazole)s and polyaramids, and is preferably one having an aromatic group in the backbone chain of the polymer.

The at least one halogen-containing reactive group is preferably represented by —R⁶—(X)ₚ, wherein R⁶ is carbon or a branched or straight chain organic group selected from alkyl, alkenyl, aryl and aralkyl groups of from 1 to about 30 carbon atoms having from 0 to about 10 ester or ether groups along or in a chain or structure of the group, preferably from 0 to about 5 of such groups, and wherein R⁶ may be substituted or unsubstituted; and wherein X is a halogen atom and p is an integer that is 1 or 2.

In one embodiment herein, the alkali metal compound is selected from the group consisting of R⁵-M′, wherein M′ is an alkali metal and R⁵ is H or a branched or straight chain organic group selected from alkyl, alkenyl, aryl and aralkyl groups of from 1 to about 30 carbon atoms having from 0 to about 10 ester or ether groups, preferably 0 to about 5 such groups, along or in a chain or structure of the group, and wherein R⁵ may be substituted or unsubstituted.

The organic polymer having the at least one halogen-containing end group is preferably reacted with the alkali metal compound in a solvent according to an embodiment of the method described herein. The solvent is preferably one which is capable of dissolving the organic polymer having the at least one halogen-containing reactive group and is free of functional groups that react with the halogen in the halogen-containing reacting group under reaction conditions in step (a) noted above. Suitable solvents include a heptane, a hexane, tetrahydrofuran, and a diphenyl ether. The organic polymer having the at least one halogen-containing end group is also preferably dried prior to reacting with the alkali metal compound in the solvent.

The first reaction step of a dehalogenation treatment preferably occurs at a temperature of less than about −20° C., and more preferably about −70° C. for a period of about 2 hours.

Step (c) of the method of controlling the cross-linking reaction rate of an organic polymer as noted above, comprises reacting the dehalogenated organic polymer with a cross-linking compound having a structure selected from:

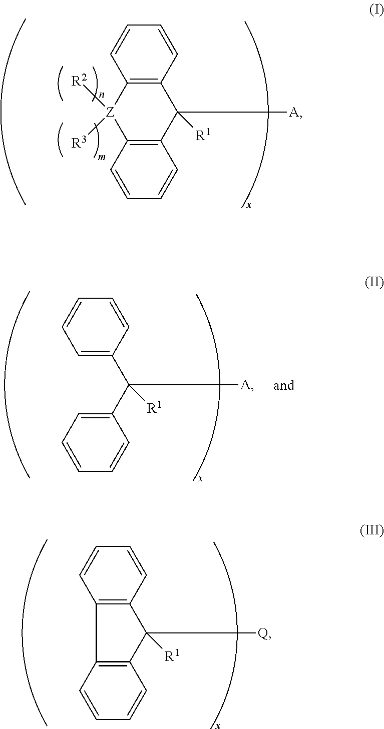

wherein Q is a bond, wherein A is Q, an alkyl, an aryl, or an arene moiety having a molecular weight less than about 10,000 g/mol, wherein R¹, R², and R³ have a molecular weight less than about 10,000 g/mol and are the same or different and are selected from the group consisting of hydrogen, hydroxyl (—OH), amine (—NH₂), halide, ether, ester, amide, aryl, arene, or a branched or straight, saturated or unsaturated alkyl group of one to about six carbon atoms, wherein m is from 0 to 2, n is from 0 to 2, and m+n is greater than or equal to zero and less than or equal to two, wherein Z is selected from the group of oxygen, sulfur, nitrogen, and a branched or straight, saturated or unsaturated alkyl chain of one to about six carbon atoms, and wherein x is about 1.0 to about 6.0.

Step (c) may also further comprise providing a cross-linking reaction additive selected from an organic acid and/or an acetate compound, wherein the cross-linking reaction additive is capable of reacting with the cross-linking compound to form a reactive intermediate in the form of an oligomer, which reactive intermediate oligomer is capable of cross-linking the dehalogenated organic polymer.

Step (c) noted above may also include heating the cross-linking compound of the type described above and the cross-linking reaction additive in a separate composition such that oligomerization of the cross-linking compound occurs to form the reactive intermediate oligomer. The method may also comprise adding the reactive intermediate oligomer to the dehalogenated organic polymer to form a cross-linkable composition and then cross-linking the cross-linkable composition to form a cross-linked organic polymer.

In another embodiment described herein, the invention relates to a method of preparing an elastomeric material, comprising the steps of (a) providing an aromatic polymer which is nonelastomeric at room temperature; (b) cross-linking the aromatic polymer using a cross-linking compound having a structure selected from the group of formula (I), formula (II), and formula (III) to form a cross-linked aromatic polymer that is substantially cured; and (c) heating the cross-linked aromatic polymer to a temperature at or above a glass transition temperature of the cross-linked aromatic polymer.

In one embodiment of the method of preparing an elastomeric material, in step (b), the aromatic polymer is at least about 80% cured, preferably at least about 90% cured, and more preferably fully cured.

The aromatic polymer used in the method may be selected from the group consisting of poly(arylene ether)s, polysulfones, polyethersulfones, polyarylene sulfides, polyimides, polyamides, polyureas, polyurethanes, polyphthalamides, polyamide-imides, poly(benzimidazole)s, polyarylates, liquid crystalline polymers (LCPs) and polyaramids. In one embodiment, the aromatic polymer is a poly(arylene ether) including polymer repeating units having the structure of formula (XIII) as discussed above. Further, in some embodiments the organic polymer is a poly(arylene ether) including polymer repeating units having the structure of formula (XIV).

In one embodiment, in step (b) of the method of preparing an elastomeric material further comprises cross-linking the organic polymer with the cross-linking compound and a cross-linking reaction additive selected from an organic acid and/or an acetate compound, wherein the cross-linking reaction additive is capable of reacting with the cross-linking compound to form a reactive intermediate in the form of an oligomer, which reactive intermediate oligomer is capable of cross-linking the organic polymer.

The method of preparing an elastomeric material may further include forming a composition comprising the cross-linked organic polymer and heating the composition to form a molded article, wherein step (c) further comprises placing the molded article in use at a temperature at or above the glass transition temperature of the cross-linked organic polymer.

The present invention further includes an elastomeric material formed by heating a cross-linked aromatic polymer that is substantially cured at or above a glass transition temperature of the cross-linked aromatic polymer, wherein the aromatic polymer is not elastomeric at room temperature prior to cross-linking, and wherein the aromatic polymer is cross-linked by reaction with a cross-linking compound or by thermally induced cross-linking of an aromatic polymer having a graft bonded to the aromatic polymer.

The invention includes an elastomeric article formed by heat molding a composition comprising a cross-linked aromatic polymer to form a molded article, wherein the aromatic polymer is not elastomeric at room temperature prior to cross-linking, and wherein the cross-linked aromatic polymer is substantially cured, and heating the molded article at or above a glass transition temperature of the cross-linked aromatic polymer, wherein the aromatic polymer is cross-linked by reaction with a cross-linking compound or by thermally induced cross-linking of an aromatic polymer having a graft bonded to the aromatic polymer. The elastomeric article is selected from the group consisting of an O-ring, a V-cup, a U-cup, a gasket, at least one component of a seal stack, a packer element, a diaphragm, a the seal, a bearing, a valve seat, an adapter, a wiper ring, a chevron seal back-up ring, and tubing.

The invention also includes a method of using an organic polymer that is not elastomeric at room temperature in an elastomeric application, comprising cross-linking the organic polymer using a cross-linking compound selected from formula (I), (II), or (III) to form a cross-linked organic polymer to substantially cure the aromatic polymer; and heating the cross-linked polymer in use at or above a glass transition temperature of the cross-linked polymer such that it becomes elastomeric.

The method may further comprise forming a composition comprising the cross-linked organic polymer, molding the composition into a molded article, placing the molded article in use and heating the molded article in use so as to heat the cross-linked polymer at or above the glass transition temperature of the cross-linked polymer.

The invention further has an embodiment including a method of preparing an elastomeric material. The method comprises (a) providing an aromatic polymer which is non-elastomeric at room temperature; (b) cross-linking the aromatic polymer using a cross-linking compound to form a cross-linked aromatic polymer, wherein the cross-linking compound has a structure selected from one or more of the group of

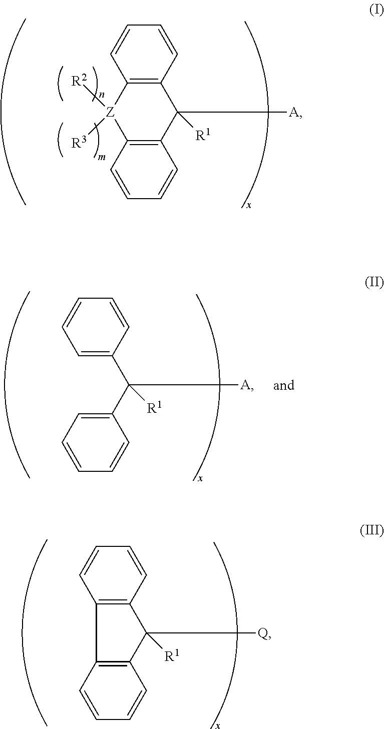

wherein Q is a bond, wherein A is Q, an alkyl, an aryl, or an arene moiety having a molecular weight less than about 10,000 g/mol, wherein R¹, R², and R³ have a molecular weight less than about 10,000 g/mol and are the same or different and are selected from the group consisting of hydrogen, hydroxide (—OH), amine (—NH₂), halide, ether, ester, amide, aryl, arene, or a branched or straight, saturated or unsaturated alkyl group of one to about six carbon atoms, wherein m is from 0 to 2, n is from 0 to 2, and m+n is greater than or equal to zero and less than or equal to two, wherein Z is selected from the group of oxygen, sulfur, nitrogen, and a branched or straight, saturated or unsaturated alkyl chain of one to about six carbon atoms, and wherein x is about 1.0 to about 6.0; and (c) heating the cross-liked aromatic polymer to a temperature at or above a glass transition temperature of the cross-linked aromatic polymer.

In the method of preparing an elastomeric material, in step (b), the aromatic polymer is preferably at least about 80% cured, more preferably at least about 90% cured and most preferably, it is fully cured. The aromatic polymer in the method may be one or more of poly(arylene ether)s, polysulfones, polyethersulfones, polyarylene sulfides, polyimides, polyamides, polyureas, polyurethanes, polyphthalamides, polyamide-imides, poly(benzimidazole)s, polyarylates, liquid crstalline polymers (LCPs) and polyaramids.

In one embodiment, the aromatic polymer is a poly(arylene ether) including polymer repeating units having the structure of formula (XIII) as discussed above. In some embodiments, the organic polymer is a polyarylene ether according to formula (XIV).

In this method, step (b) may further comprise cross-linking the organic polymer with the cross-linking compound and a cross-linking reaction additive selected from an organic acid and/or an acetate compound as discussed above, wherein the cross-linking reaction additive is capable of reacting with the cross-linking compound to form a reactive intermediate in the form of an oligomer, which reactive intermediate oligomer is capable of cross-linking the organic polymer.

In another embodiment according to the present invention, the present invention relates to a method of improving extrusion- and creep-resistance of a component for use in a high temperature sealing element or seal connector, comprising: providing a composition comprising aromatic polymer and a cross-linking compound of a structure according to formula (I), formula (II), and/or formula (III), and subjecting the composition to a heat molding process to form the component and cross-link the aromatic polymer.

The aromatic polymer may be one or more of a polyarylene polymer, a polysulfone, a polyphenylene sulfide, a polyimide, a polyamide, a polyurea, a polyurethane, a polyphthalamide, a polyamide-imide, an aramid, a polybenzimidazole, and blends, copolymers and derivatives thereof. Preferably, the aromatic polymer is a polyarylene polymer and/or a polysulfone polymer, and blends, copolymers and derivatives thereof.

When the aromatic polymer is a polyarylene ether polymer, it may have repeating having units of the structure according to formula (XIV).

If the aromatic polymer is a polyarylene-type polymer, it is preferably at least one of polyetheretherketone, polyetherketone, polyetherketoneetherketoneketone, polyetherketoneketone, polysulfone, polyphenylene sulfide, polyethersulfone, polyarylsulfone, and blends, copolymers and derivatives thereof.

The composition for formation of an extrusion-resistant sealing member may also include a cross-linking reaction additive capable of reacting with the cross-linking compound to form a reactive intermediate in the form of an oligomer, which reactive intermediate oligomer is capable of cross-linking an organic polymer. The cross-linking reaction additive may be an organic acid which may be glacial acetic acid, formic acid, and/or benzoic acid. In another embodiment, the cross-linking reaction additive may be an acetate compound that has a structure according to formula (XII).

The compositions for forming extrusion resistant sealing members may be unfilled compositions providing enhanced ductility in use, or they may be filled if the user desires to modify the properties of the composition.

The invention also includes sealing components of a sealing assembly formed by a method comprising the step of cross-linking a composition as described herein. A sealing connector is also included herein having a seal connector body formed by a method comprising the step of cross-linking a composition as described herein.

Also included herein are sealing components and sealing connectors formed by the method of improving extrusion- and creep-resistance of a component for use in a high temperature sealing element or seal connector as described above, wherein the composition may be filled or unfilled. The sealing component is a seal back-up element, a packer element, a labyrinth seal or a dual-lip sealing component.

### BRIEF DESCRIPTION OF THE SEVERAL VIEWS OF THE DRAWING(S)

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1 shows a graph of dynamic viscosity measurements over time during cross-linking of an organic polymer composition.

FIG. 2 is a photographic representation of a Prior Art PEEK back-up ring tested at 300° F. (149° C.) with 21,000 psi applied hydrostatic pressure to the top surface for 24 hours, wherein extrusion of 0.19 mm was measured on the outer edge of the ring.

FIG. 3 is a photographic representation of the bottom surface of a Prior Art PEEK back-up ring tested at 450° F. (237° C.) with 11,000 psi applied hydrostatic pressure to the top surface for 24 hours. This loading at high temperature resulted in extrusion of 0.30 mm, a 60% increase in extrusion over that in FIG. 1, but at only one-half the applied pressure.

FIG. 4 is a Prior Art SealConnect® connector formed of polyether ketone (PEK) before and after application of 20,000 psi hydrostatic pressure and 300° F. (149° C.) for 24 hours.

FIG. 5 is a differential scanning calorimetry graph showing the heat flow as a function of temperature for each of an inventive blend and a comparative sample were heated during a second heating step.

FIG. 6 is a rheology time sweep at 380° C. from a parallel plate rheometer for an inventive blend and a comparative sample.

### DETAILED DESCRIPTION OF THE INVENTION

Described herein are cross-linking compounds for forming cross-linked organic polymers. Further provided are cross-linking compositions comprising a cross-linking compound and one or more reactive cross-linking additives. Also within the invention are organic polymer compositions for use in forming a cross-linked organic polymer, methods for preparing such compositions and polymers, and articles of manufacture formed from the aforementioned compositions and by such methods, which are useful in extreme condition end applications such as in downhole applications, and/or as substitutes for traditional elastomers.

Provided are polymeric materials with thermal stability at high temperatures and a method and composition that cross-links high glass transition polymers to form thermally stable, cross-linked polymer systems. In particular the composition of the present disclosure provides new and additional cross-linkers for high glass transition polymers as low cost alternatives that are easy to process in comparison to Applicant's prior cross-linker, exemplified in U.S. Pat. No. 9,006,353.

The cross-linking compounds of the present invention can be synthesized using the Grignard reaction, wherein an alkyl, vinyl or aryl-magnesium halide, known as a Grignard reagent, adds to a carbonyl group in an aldehyde or ketone to form one or more carbon-carbon bonds. This reaction can be performed under relatively mild reaction conditions relative to those used to prepare the cross-linkers of U.S. Pat. No. 9,006,353. Further, U.S. Pat. No. 9,006,353 may require a hazardous chemical reactant, tert-butyllithium, which is not required to synthesize the cross-linking compounds of the present invention. Furthermore, the use of mild reaction conditions and less hazardous chemicals allows the cross-linking compounds of the present invention to be prepared with less expense.

In an illustrative example, a cross-linking compound of the present invention can be formed via the following reaction:

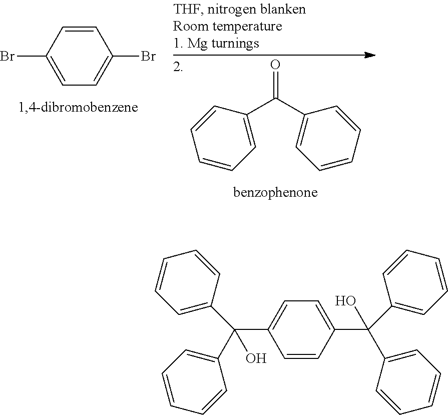 [SMILES: Brc1ccc(Br)cc1 ; O=C(c1ccccc1)c1ccccc1 ; OC(c1ccccc1)(c1ccccc1)c1ccc(C(O)(c2ccccc2)c2ccccc2)cc1]

This reaction can be carried out at room temperature and does not require the use of harsh or extremely hazardous chemicals, allowing for formation of a crosslinking compound as shown.

The cross-linked high glass transition temperature polymers according to the present disclosure are thermally stable at temperatures greater than 260° C., greater than 400° C. or up to about or greater than 500° C. The composition according to the present disclosure is usable with unmodified polymers. Polymers with thermal stability up to 500° C. provide opportunities in manufactured articles in terms of utility in scope of application. There are numerous product applications which require a polymer part, which has thermal stability up to 500° C. Certain embodiments of the present disclosure include a high cross-link density. By having a high cross-link density, the glass transition temperature of the polymer formed inherently increases and the susceptibility to swell decreases when exposed to solvents.

As previously observed by the Applicant in U.S. Pat. No. 9,006,353, there is an advantage to adding a cross-linking additive to an unmodified polymer to achieve cross-linking, compared to modification of the polymer by grafting a cross-linking moiety to the polymer. Previously, modification of the polymer required dissolving the polymer into an appropriate solvent, so that chemical grafting of the cross-linking moiety to the polymer could be performed. To overcome this limitation, U.S. Pat. Nos. 9,006,353 and 9,109,080 disclosed cross-linking compounds, cross-linking compositions, methods of forming cross-linked organic polymers, and molded articles formed therefrom. However, the cross-linking compounds of these patents relate to a limited range of compounds that can be expensive or difficult to produce. As a result, there is a continued need in the art for a wider variety of cross-linking compounds that are effective as cross-linkers and can be more efficiently and easily produced.

One or more cross-linking compounds is/are present in the cross-linking composition and organic polymer compositions herein. Preferably, the cross-linking compound has at least one of the following structures, or the cross-linking compound is a blend of compounds having the following structures, or the cross-linking compound is a blend of one or more compounds having the following structure with one or more additional cross-linkers, such as those disclosed in U.S. Pat. No. 9,006,353, wherein the present invention provides cross-linking compounds having the following structures:

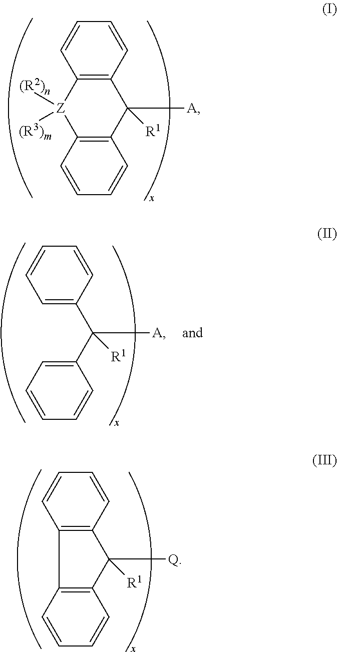

In formula (III), Q is a bond, and in formulas (I) and (II), A can be any of Q, an alkyl, an aryl, or an arene moiety. The moiety, A, whether it be an alkyl, aryl or arene group, preferably has a molecular weight less than about 10,000 g/mol. Additionally, each of R¹, R², and R³ has a molecular weight less than about 10,000 g/mol. Each of R¹, R², and R³ are selected from the group of hydrogen, hydroxyl (—OH), amine (—NH₂), halide, ether, ester, amide, aryl, arene, or a branched or straight chain, saturated or unsaturated alkyl group of one to about twelve carbon atoms, and preferably of one to about six carbon atoms. R¹, R², and R³ can each be the same group, two of R¹, R², and R³ may be the same with the third being different, or they may each be different from one another. In formula (I), m is from 0 to 2, n is from 0 to 2, and m+n is greater than or equal to zero and less than or equal to two, such that in some embodiments there is neither an R² nor an R³ group present, both R² and R³ are present, or either two R² groups or two R³ groups are present. Further, in formula (I), Z is selected from the group of oxygen, sulfur, nitrogen, and a branched or straight chain, saturated or unsaturated alkyl group of one to about six carbon atoms, and wherein x is about 1.0 to about 6.0.

The cross-linking site may be R¹ in any of formulas (I), (II), or (III) for forming more complex cross-linking compound structures, including for example, without limitation:

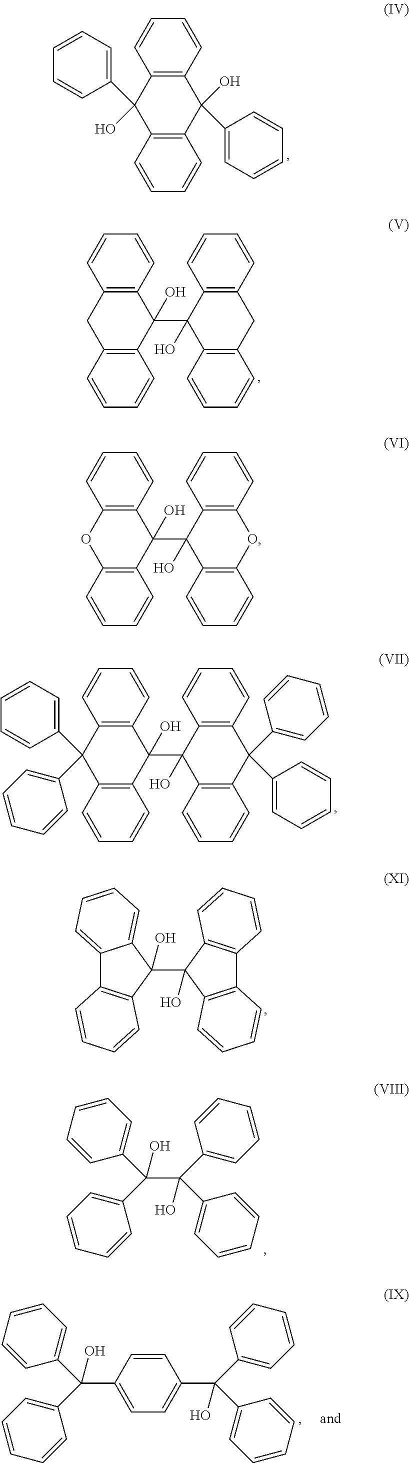

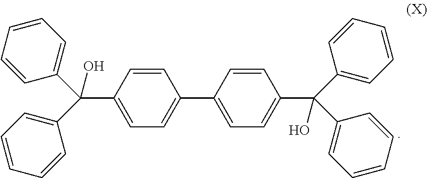 [SMILES: OC(c1ccccc1)(c1ccccc1)c1ccc(-c2ccc(C(O)(c3ccccc3)c3ccccc3)cc2)cc1]

The aryl, alkyl, or arene moiety A may be varied to have different structures, including, but not limited to the following:

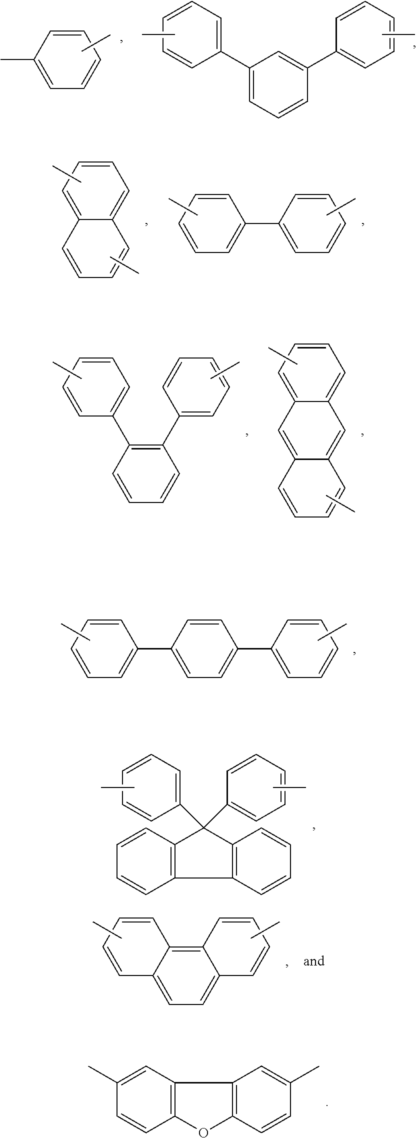

A is preferably a mirror image of the remainder of the structure shown in formula (I), formula (II), or formula (III). However, in some embodiments, A may be another structure, such as the diradical of 4,4′-biphenyl, or

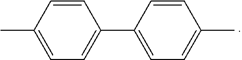

The arene, aryl, or alkyl moiety A may also be functionalized, if desired, using one or more functional groups such as, for example, and without limitation, sulfate, phosphate, hydroxyl, carbonyl, ester, halide, or mercapto.

The organic polymer composition for use in forming a cross-linked polymer includes a cross-linking compound as described above and at least one organic polymer. The at least one organic polymer may be one of a number of higher glass transition temperature organic polymers, such as, but not limited to poly(arylene ether)s, polysulfones, polyethersulfones, polyimides, polyamides, polyureas, polyurethanes, polyphthalamides, polyamide-imides, poly(benzimidazole)s and polyaramids. Preferably the polymers are non-functionalized, in that they are chemically inert and they do not bear any functional groups that are detrimental to their use in downhole tool articles of manufacture or end applications. However, in some embodiments, the polymers are functionalized as desired to achieve specific properties or as needed for specific applications.

More preferably, the organic polymer is a poly(arylene ether) including polymer repeating units of the structure according to formula (XIII):

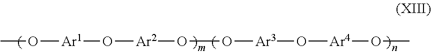

wherein Ar¹, Ar², Ar³ and Ar⁴ may be the same or different aryl radicals, such as those groups listed above as the arene moieties for the cross-linking compound, m=0 to 1.0, and n=1-m.

More preferably, the organic polymer is a poly(arylene ether) having a structure according to the general structure above wherein n is 0 and m is 1, with repeating units according formula (XIV) and having a number average molecular weight (Mn) of about 10,000 to about 30,000:

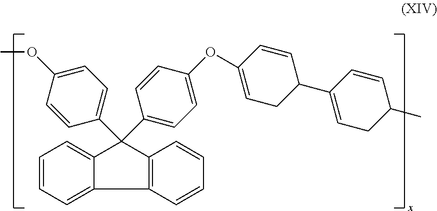

Such organic polymers may be obtained commercially for example, as Ultura™ from Greene, Tweed and Co., Inc., Kulpsville, Pa.

The cross-linking composition comprising a cross-linking compound as described above is mixed with the polymer to form a homogenous mixture. Blending of the cross-linking compounds into the polymer can be performed in various ways. One such way is dissolving both the polymer and cross-linking compound in a common solvent, then removing the solvent via evaporation or addition of a non-solvent to cause co-precipitation of polymer and cross-linking compound. In some cases, a common solvent may not exist or be convenient, in those cases alternate blending procedures are required, such as blending in an extruder, ball mill, or cyrogrinder. The mixing process is preferably accomplished at a temperature during mixing that does not exceed about 250° C., so that premature curing does not occur during the mixing process. In mechanical mixing, the resulting mixture is homogeneous in order to get uniform cross-linking.

The mixture is cured by exposing the mixture to temperatures greater than 250° C., for example, from about 250° C. to about 500° C.

While not desiring to be bound by theory, it is believed at temperatures greater than 250° C., the hydroxyl functionality of the cross-linking compound is dissociated from the remainder of the additive to afford a carbocation which then can undergo a Friedel-Crafts alkylation of the aromatic polymer, resulting in bond formation. The process is repeated with other hydroxyl moieties in the additive to form cross-links.

In such embodiment as shown below, the cross-linking compound when heated to a temperature of 250° C. or greater dissociates the hydroxyl functionalities to form carbocations, as follows:

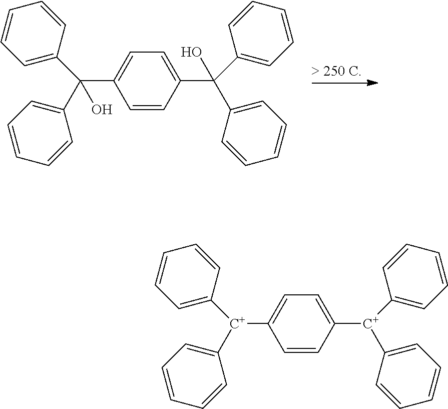

The carbocations can then be reacted by Friedel-Crafts alkylation with aromatic polymers, resulting in polymer cross-linking.

In another embodiment of the present invention, the cross-linking composition contains a cross-linking compound(s) as described above and a cross-linking reaction additive(s). The cross-linking reaction additive may be an organic acid, such as glacial acetic acid, formic acid, and/or benzoic acid.

The cross-linking reaction additive may be an acetate compound that has a structure according to formula (XII):

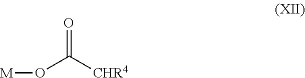

wherein M is a Group I or a Group II metal; and R⁴ is an alkyl, aryl, or aralkyl group, wherein the alkyl group is a hydrocarbon group of 1 to about 30 carbon atoms, preferably about 1 to about 15 carbon atoms having 0 to about 10 ester or ether groups along or in the chain of the hydrocarbon group, preferably about 0 to about 5 ester or ether groups, wherein R⁴ may have 0 to about 10, preferably about 0 to about 5, functional groups that may be one or more of sulfate, phosphate, hydroxyl, carbonyl, ester, halide, mercapto or potassium. More preferably, the acetate compound may be lithium acetate hydrate, sodium acetate, and/or potassium acetate, and salts and derivatives thereof.

The weight percentage ratio of the cross-linking compound to the cross-linking reaction additive may be about 10:1 to about 10,000:1, and more preferably about 20:1 to about 1000:1.

The cross-linking compound(s) and a cross-linking reaction additive(s) can be reacted to form a reactive oligomerized cross-linking intermediate either in situ during thermal molding with a cross-linkable organic polymer, and/or by reacting prior to combining with a cross-linkable organic polymer and then heat molding to form an article. This intermediate oligomer reaction product of the cross-linking compound with the cross-linking reaction additive enables control of a cross-linking reaction when combined with an organic polymer and can enable a lower rate of thermal cure, to allow a broader window and better control during heat molding of the resultant cross-linked organic polymer.

In another embodiment, the invention includes an organic polymer composition for use in forming a cross-linked organic polymer, comprising a cross-linking compound having a structure selected from one or more of formula (I), formula (II), and formula (III) as described above; a cross-linking reaction additive selected from an organic acid and/or an acetate compound; and at least one organic polymer, wherein the cross-linking reaction additive is capable of reacting with the cross-linking compound to form a reactive intermediate in the form of an oligomer, which reactive intermediate oligomer is capable of cross-linking the organic polymer.

In a further embodiment, the invention includes an organic polymer composition for use in forming a cross-linked organic polymer, comprising an organic polymer and a reactive cross-linking oligomer which is a reaction product of a cross-linking compound having a structure selected from the group of formula (I), formula (II), and formula (III) as described above and a cross-linking reaction additive selected from an organic acid and/or an acetate compound.

Also described herein is a cross-linked organic polymer composition capable of providing an inhibited and/or controlled cross-linking reaction rate and a method for molding articles from cross-linked organic polymers using such compositions. The compositions and methods herein enable easier use of traditional (or non-traditional) heat molding techniques to form articles from cross-linked organic compounds without worrying about the window of process formation being inconsistent with the rate of cure, so that premature cross-linking curing is reduced or eliminated during part formation resulting in uniform parts formed from more easy-to-process compositions.

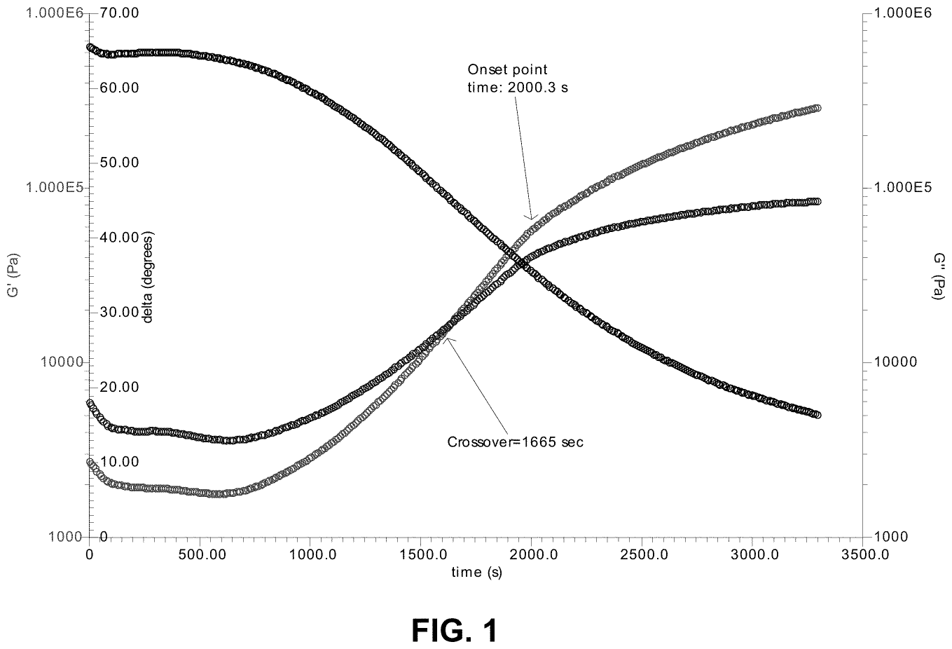

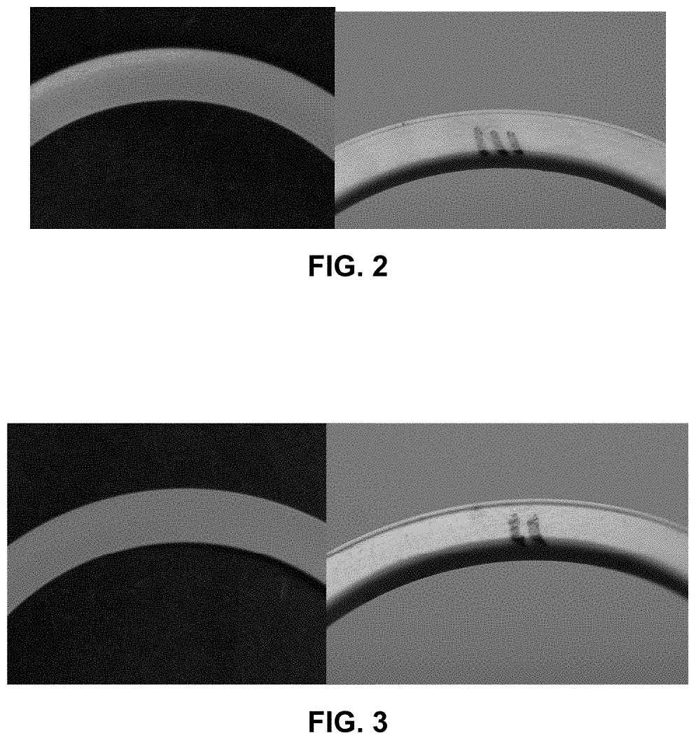

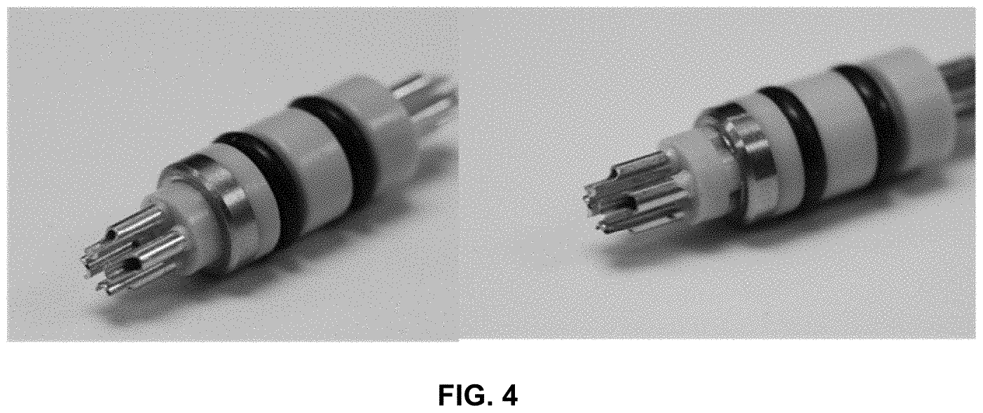

In general, formation of cross-links in an organic polymer cross-linking to itself or in an organic polymer composition comprising an unmodified cross-linking compound may be completed within about 2 minutes at about 380° C., the typical processing temperature of polyetherether ketone (PEEK). The extent of this reaction can be tracked by dynamic viscosity measurements. Two methods are often used to judge when a reaction may be completed. The point where storage modulus G′ equals Loss modulus G″, called the crossover point or gel point, indicates the onset of gel formation where cross-linking has produced an interconnected. As curing continues, G′ will increase, which is an indication of cross-link density. As curing continues, eventually G′ will level off, which indicates that most curing is completed. The inflection point G′, which indicates onset of vitrification can also be used in cases where no obvious cross-over point can be determined (See FIG. 1). The time required to attain G′, G″ crossover or the onset of vitrification can be used as the upper limit of process time for a thermosetting material.

As Applicant previously noted in U.S. Pat. No. 9,109,080, assigned to Applicant and incorporated herein by reference in relevant part, utilization of one or more cross-linking reaction additive(s) in the invention helps to provide polymers with high glass transition temperatures and high cross-link density. Polymers with high thermal stability of up to 500° C. and high cross-link density, while desirable, display a very high melt viscosity before further processing, and thus are very difficult to melt process. As curing of the cross-linked polymer may be initiated during heat molding, it is desirable to control when cross-linking begins. If the rate of cross-linking is not controlled before molding of a composition into a final article, the article of manufacture may begin to prematurely cure before or during heat molding or proceed too rapidly causing incomplete mold fill, equipment damage, and inferior properties in the article. Thus, the cross-linking reaction additive helps to improve control of the rate of cross-link formation in an organic polymer. The present invention provides new and additional cross-linking compounds that are more easily produced than previous cross-linking compounds that can be used with the cross-linking reaction additive for cross-linking organic polymers to delay the onset of cross-linking in the organic polymer for as much as several minutes to allow for rapid processing and shaping of the resultant organic polymer structures in a controlled manner.

The cross-linking reaction additive(s) include organic acids and/or acetate compounds, which can promote oligomerization of the cross-linking compound. In one embodiment, the oligomerization can be carried out by acid catalysis using one or more organic acid(s), including glacial acetic acid, acetic acid, formic acid, lactic acid, citric acid, oxalic acid, uric acid, benzoic acid and similar compounds. An oligomerization reaction using one of the cross-linking compounds listed above is as follows:

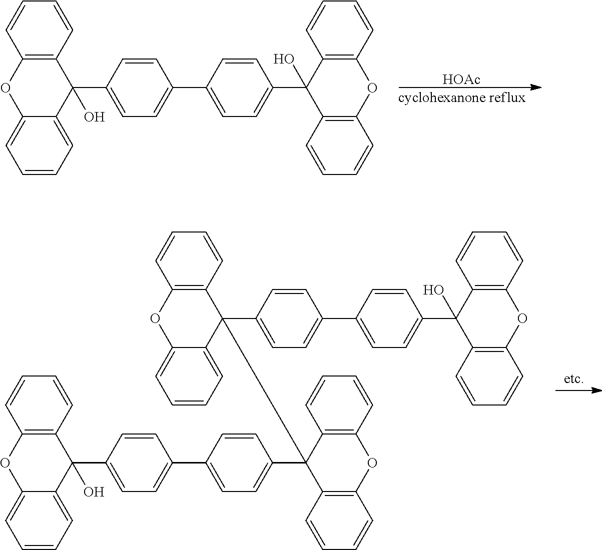 [SMILES: OC1(c2ccc(-c3ccc(C4(O)c5ccccc5Oc5ccccc54)cc3)cc2)c2ccccc2Oc2ccccc21 ; OC1(c2ccc(-c3ccc(C4(C5(c6ccc(-c7ccc(C8(O)c9ccccc9Oc9ccccc98)cc7)cc6)c6ccccc6Oc6ccccc65)c5ccccc5Oc5ccccc54)cc3)cc2)c2ccccc2Oc2ccccc21 ; "HOAc"]

In other embodiments, inorganic acetate compounds, such as those having a structure according to formula (XII) below may also be used instead of or in combination with the organic acids:

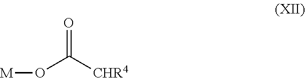

wherein M is a Group I or a Group II metal. R⁴ in formula (XII) may preferably be an alkyl, aryl or aralkyl group. For example, R⁴ may be a hydrocarbon group of 1 to about 30 carbon atoms, preferably 1 to about 15 carbon atoms, including normal chain and isomeric forms of methyl, ethyl, propyl, butyl, pentyl, hexyl, heptyl, octyl, nonyl, decyl, ethenyl, propenyl, butenyl, hexenyl, heptenyl, octenyl, nonenyl, decenyl, and the like. R⁴ may also have from 0 to about 10 ester or ether groups along or in a chain of the hydrocarbon group, and preferably about 0 to about 5 such ester or ether groups. Suitable R⁴ aryl and aralkyl groups, including those based on phenyl, naphthyl, and similar groups, which may each include optional lower alkyl groups on the aryl structure of from 0 to about 10 carbon atoms, preferably about 0 to about 5 carbon atoms. R⁴ may further include 0 to about 10, preferably 0 to about 5, functional groups if desired such as sulfate, phosphate, hydroxyl, carbonyl, ester, halide, mercapto and/or potassium on the structure.

Oligomerization of the cross-linking compound with an acetate compound can afford the same resultant oligomerized cross-linking composition as achieved when adding an organic acid. The cross-linking reaction additive may be lithium acetate hydrate, sodium acetate, potassium acetate, rubidium acetate, cesium acetate, francium acetate, beryllium acetate, magnesium acetate, calcium acetate, strontium acetate, barium acetate, and/or radium acetate, and salts and derivatives thereof. More preferably, the cross-linking reaction additive is lithium acetate hydrate, sodium acetate and/or potassium acetate, and salts and derivatives of such compounds.

The cross-linking composition preferably has a weight percentage ratio of the cross-linking compound to the cross-linking reaction additive of about 10:1 to about 10,000:1, and more preferably about 20:1 to about 1000:1 for achieving the best results. In making the cross-linking composition, in one embodiment, the components are combined prior to addition of an organic polymer to make an organic polymer composition. Alternatively, they may all be combined simultaneously.

The amount of the cross-linking compound in the cross-linking composition is preferably about 70% by weight to about 98% by weight, more preferably about 80% by weight to about 98% by weight, and most preferably about 85% by weight to about 98% by weight based on the weight of the cross-linking composition. The amount of the cross-linking reaction additive in the cross-linking composition is preferably about 2% by weight to about 30% by weight, more preferably about 2% by weight to about 20% by weight, and most preferably about 2% by weight to about 15% by weight.

The organic polymer composition preferably has a weight percentage ratio of the organic polymer to the combined weight of the cross-linking compound and the cross-linking reaction additive of about 1:1 to about 100:1, and more preferably about 3:1 to about 10:1 for achieving the best results.

The amount of the cross-linking compound in the organic polymer composition is preferably about 1% by weight to about 50% by weight, more preferably about 5% by weight to about 30% by weight, and most preferably about 8% by weight to about 24% by weight based on the total weight of an unfilled organic composition including the cross-linking compound, the cross-linking reaction additive and the organic polymer.

The amount of the cross-linking reaction additive in the organic polymer composition is preferably about 0.01% by weight to about 33% by weight, more preferably about 0.1% by weight to about 10% by weight, and most preferably about 0.2% by weight to about 2% by weight based on the total weight of an unfilled organic polymer composition including the cross-linking compound, the cross-linking reaction additive and the organic polymer.

The amount of the organic polymer in the organic polymer composition is preferably about 50% by weight to about 99% by weight, more preferably about 70% by weight to about 95% by weight, and most preferably about 75% by weight to about 90% by weight based on the total weight of an unfilled organic polymer composition including the cross-linking compound, the cross-linking reaction additive and the organic polymer.

The organic polymer composition may further be filled and/or reinforced and include one or more additives to improve the modulus, impact strength, dimensional stability, heat resistance and electrical properties of composites and other finished articles of manufacture formed using the polymer composition. These additive(s) can be any suitable or useful additives known in the art or to be developed, including without limitation continuous or discontinuous, long or short, reinforcing fibers such as, for example, carbon fiber, glass fiber, woven glass fiber, woven carbon fiber, aramid fiber, boron fiber, PTFE fiber, ceramic fiber, polyamide fiber and the like; and/or one or more fillers such as, for example, carbon black, silicate, fiberglass, calcium sulfate, boron, ceramic, polyamide, asbestos, fluorographite, aluminum hydroxide, barium sulfate, calcium carbonate, magnesium carbonate, silica, alumina, aluminum nitride, borax (sodium borate), activated carbon, pearlite, zinc terephthalate, graphite, talc, mica, silicon carbide whiskers or platelets, nanofillers, molybdenum disulfide, fluoropolymer fillers, carbon nanotubes and fullerene tubes. Preferably, the additive(s) include reinforcing fiber such as continuous or discontinuous, long or short, carbon fiber, PTFE fiber, and/or glass fiber.

In making the organic polymer composition, it is preferred that the additive(s) is/are added to the composition along with or at about the same time that the oligomerized cross-linking composition (or the combined components thereof) is combined with the organic polymer to make an organic polymer composition, however, the manner of providing reinforcing fibers or other fillers may be according to various techniques for incorporating such materials and should not be considered to limit the scope of the invention. The amount of additives is preferably about 0.5% by weight to about 65% by weight based on the weight of the organic polymer composition, and more preferably about 5.0% by weight to about 40% by weight.

In addition, the organic polymer composition may further comprise other compounding ingredients, including stabilizers, flame retardants, pigments, plasticizers, surfactants, and/or dispersants such as those known or to be developed in the art to aid in the manufacturing process. In making the organic polymer composition, it is preferred that the one or more fillers is/are added to the organic polymer composition along with or at about the same time that the oligomerized cross-linking composition (or the combined components thereof) is combined with the organic polymer to make an organic polymer composition, however, as noted above, the manner of providing such materials may be according to various techniques and should not be considered to limit the scope of the invention. The amount of the compounding ingredients that can be combined into the organic polymer composition, if used, is preferably about 5% by weight to about 60% by weight of a total of such ingredients based on the weight of the organic polymer composition, more preferably about 10% by weight to about 40% by weight, and most preferably about 30% by weight to about 40% by weight.

In an embodiment of the method of the invention, after providing, for example by manufacturing, a cross-linking composition as described herein, the cross-linking composition is heated to induce oligomerization of the cross-linking compound. In one embodiment of the method, the oligomerization occurs by acid catalysis. Acid catalysis is used when an organic acid is employed as the cross-linking additive. The R¹ functionality of the cross-linking compound of formula (I), formula (II), or formula (III) is dissociated from the remainder of the compound to afford a carbocation which then can undergo a Friedel-Crafts alkylation of the organic polymer, resulting in bond formation. In another embodiment of the method of the present invention, oligomerization of the cross-linking compound may occur by doping. Doping is accomplished by physically mixing solid form reactants in the composition at lower temperatures of about −100° C. to about −300° C. prior to reacting the overall composition for curing and/or heat molding the resulting composition to form an article.

The method may further comprise adding the reacted oligomerized cross-linking composition to an organic polymer to form a cross-linkable composition. The unmodified cross-linking compound may be added directly to the organic polymer and blended with the cross-linking reaction additive to simultaneously oligomerize and bind to the organic polymer. Once the reactive oligomerized cross-linking compound reacts with the organic polymer, the rate of cross-linking of the organic polymer occurs at a later time in the curing process. The result is complete filling of the mold and a more excellent end heat molded/extruded, etc. product formed from the composite polymer during various heat molding techniques.

Powders of the organic polymer compositions of the present invention can be made into pellets, and subjected to a heat molding process. Heat molding of the organic polymer compositions can be accomplished by many different means already known or to be developed in the art, including extrusion, injection molding, compression molding and/or injection/compression molding. Pellets of an organic polymer composition of the present invention can be injection molded on an Arbug® 38-ton injection molding machine with a cold runner system that includes a hot sprue.

Heat molding to form an article of manufacture may be accomplished by any method known or to be developed in the art including but not limited to heat cure, cure by application of high energy, press cure, steam cure, a pressure cure, an e-beam cure, or cure by any combination of means, etc. Post-cure treatments as are known in the art or to be developed may also be applied, if desired. The organic polymer compositions of the present invention are cured by exposing the composition to temperatures greater than about 250° C. to about 500° C., and more preferably about 350° C. to about 450° C.

The compositions and/or the methods described above may be used in or to prepare articles of manufacture of downhole tools and applications used in the petrochemical industry. Particularly, the article of manufacture is selected from the group consisting of acid-resistant coatings, chemical-casted films, extruded films, solvent-casted films, blown films, encapsulated products, insulation, packaging, composite cells, connectors, and sealing assemblies in the shape of O-rings, V-rings, U-cups, gaskets, bearings, valve seats, adapters, wiper rings, chevron back-up rings, and tubing.

In U.S. Pat. No. 9,109,080, assigned to the Applicant and incorporated herein in relevant part, the Applicant found that it is possible to chemically remove the halogen from a halogen-containing end group to control the halogen-containing byproducts and enable formation of purified organic polymers, in the sense that such polymers are dehalogenated prior to cross-linking. Such dehalogenated, purified organic polymers are then capable of being easily cross-linked and molded, so that there is a slower and more compatible, controlled cross-linking reaction during molding, and traditional heat-molding techniques may be readily used. However, the '080 patent is limited to specific cross-linking compounds described therein, and it would be desirable to use a wider variety of crosslinking compounds that have good performance while also being more easily produced. Thus, the present invention provides cross-linking compounds as described herein, which are further useful in the cross-linking of dehalogenated organic polymers.

In one embodiment, the present invention provides cross-linked articles formed from cross-linking dehalogenated organic polymers using a cross-linking compound according to one of formula (I), (II), and/or (III) as described herein, and optionally one or more reactive cross-linking additives, as well as organic polymer compositions having a dehalogenated organic polymer and a cross-linking compound for use in forming a cross-linked organic polymer. In addition, methods for preparing such compositions and polymers, and articles of manufacture formed from the aforementioned compositions and by such methods are within the invention and are useful in extreme condition end-applications such as in down-hole applications.

Cross-linking compositions containing a cross-linking compound(s) according to formula (I), (II), or (III) as described herein, can be reacted to form a reactive oligomerized cross-linking intermediate either in situ during thermal molding in combination with a cross-linkable dehalogenated organic polymer, and/or by reacting a separate cross-linking composition having a cross-linking compound(s) and a cross-linking reaction additive(s) to form the oligomerized cross-linking intermediate and then combining the oligomerized cross-linking intermediate with a cross-linkable dehalogenated organic polymer and heating and molding the combined materials to form an article. The intermediate oligomer reaction product of the cross-linking compound(s) with the optional crosslinking reaction additive(s) act as inhibitors and enable control of a cross-linking reaction when combined with an organic polymer generally, particularly those with aromatic groups in the backbone, but can enable even lower rates of thermal cure and allow a broader window and better control and reaction rate inhibition during heat molding when a dehalogenated organic polymer is used as a base polymer.

Formation of cross-links in an organic polymer cross-linking to itself or in an organic polymer composition comprising an unmodified cross-linking compound may be completed within about 2 minutes at about 380° C., the typical processing temperature of polyetherether ketone (PEEK).

Utilization of one or more cross-linking reaction additive(s) can help provide polymers with high glass transition temperatures and high cross-link density cure more stably when combined with a cross-linking compound according to one or more of formulas (I), (II), or (III), which are described above. Polymers with high thermal stability of up to 500° C. and high crosslink density, while desirable, as mentioned above, display a very high melt viscosity before further processing, and thus are very difficult to melt process. If the rate of cross-linking is not controlled before molding of a composition into a final article, the article of manufacture may begin to prematurely cure before or during heat molding or proceed too rapidly causing incomplete mold fill, equipment damage, and inferior properties in the article. Thus, the invention is also directed to improving by controlling or inhibiting the rate of cross-link formation in an organic polymer using the cross-linking compound(s) described herein and/or the cross-linking reaction additive(s) as described herein in combination with a dehalogenated organic polymer, such as a debrominated organic polymer, which is capable of cross-linking. This provides a reaction wherein the inhibitor(s) (not impeded by X or HX formation, such as B or HBr) can work more effectively and delay the onset of cross-linking in the organic polymer for as much as several minutes beyond what is achieved without the dehalogenation treatment of the initial polymer to allow for rapid processing and shaping of the resultant organic polymer structures in a controlled manner.

In the organic polymer compositions herein for use in forming a cross-linked organic polymer, the composition includes at least one organic polymer that is dehalogenated. Polymers which can benefit in a preferred manner by a dehalogenation treatment prior to crosslinking in include at least one organic polymer that may be one of a number of higher glass transition temperature organic polymers and/or which have an aromatic group in the backbone of the polymer, including, but not limited to, for example, poly(arylene ether)s, polysulfones, polyethersulfones, polyimides, polyamides, polyureas, polyurethanes, polyphthalamides, polyamide-imides, poly(benzimidazole)s and polyaramids. Preferably the polymers are non-functionalized, in that they are chemically inert and they do not bear any functional groups that are detrimental to their use in down-hole tool articles of manufacture or end applications. Such polymers if able to benefit from a dehalogenation treatment prior to cross-linking would also have at least one halogen-containing reactive group. Generally such groups, as discussed above, are terminal groups which may remain from the polymerization process or other end-capping reactions and the like.

More preferably, in one embodiment herein, the organic polymer is a poly(arylene ether) such as those noted above including polymer repeating units in the backbone of the polymer chain having the structure according to formula (XIII). More preferably, the organic polymer is a poly(arylene ether) with repeating units according formula (XIV) and having a number average molecular weight (Mn) of about 10,000 to about 30,000.

Other suitable organic polymers for use in the invention as noted above, such as polyarylenes and polyarylene ethers, may be made with, for example, diiodobiphenyl monomer and/or dibromobiphenyl monomers. In such instances, the method used herein should be used to remove the bromine-containing or iodine-containing reactive groups to deiodinate or debrominate the polymer. For other suitable polymers, such as polysulfones, many are formed using chlorinated monomers in synthesis which may leave chlorine-containing reactive groups, and the method herein should be used to dechlorinate the chlorine-containing reactive groups. Thus, it should be understood to one skilled in the art, that for organic polymers having halogen-containing reactive groups that are present from formation by a polymerization process leaving reactive, halogen-containing groups, such as halogen-containing end groups, such organic polymers can be dehalogenated to provide purified organic polymers for use in cross-linking reactions where rate control is an issue in employing such polymers in traditional heat molding processes.

To dehalogenate the organic polymer, an organic polymer(s) alone or in combination may be subjected to the method described in U.S. Pat. No. 9,109,080. The method provides a dehalogenated organic polymer which works in the cross-linking composition to control the cross-linking reaction rate of an organic polymer having at least one halogen-containing reactive group during a cross-linking reaction. In the method, an organic polymer having a halogen-containing reactive group, such as those noted above, and preferably having one or two halogen-containing terminal groups, such as bromine, iodine, chlorine and the like, is used.

The polymer having the halogen-containing reactive group is reacted with an alkali metal compound to break the bond that connected the halogen atom to the polymer, that is, the bond between the organic polymer having the at least one halogen-containing reactive group and the halogen atom in the at least one halogen-containing reactive group. This reaction forms an intermediate having a carbocation.

The at least one halogen-containing reactive group is typically a halogen atom (X) but more often the halogen atom links to the chain, and most typically in a terminal position, by a final organic group off of the primary backbone. Such a reactive group may be represented as —R⁶—(X)ₚ, wherein R⁶ is carbon or a branched or straight chain organic group selected from alkyl, alkenyl, aryl and aralkyl groups of from 1 to about 30 carbon atoms, preferably 1 to about 20 carbon atoms, having from 0 to about 10 ester or ether groups, preferably 0 to about 5 such ether or ester groups along or in a chain or structure of the group, and wherein R⁶ may be substituted or unsubstituted. Suitable alkyls include methyl, ethyl, propyl, iso-propyl, butyl, iso-butyl, tert-butyl, pentyl, hexyl, heptyl and the like. Suitable alkenyls include methenyl, ethenyl, propenyl, iso-propenyl, butenyl, iso-butenyl, tert-butenyl, pentenyl, and the like. Aryl groups may be single or multiple ring structures, such as benyl, phenyl, xylyl, biphenyl, dibenzyl, and the like, and such groups may be modified to have aryl or aralkyl groups or side chains and to form aralkyl structures as well. X represents a halogen, bromine, iodine, chlorine, flourine, and the like, and p is an integer which is 1 or 2.

The reaction of the organic polymer having the halogen-containing reactive group preferably occurs with an alkali metal compound. The alkali metal compound may be represented by R⁵-M′, wherein M′ is an alkali metal and R⁵ may be H or a branched or straight chain organic group selected from alkyl, alkenyl, aryl and aralkyl groups of from 1 to about 30 carbon atoms, preferably about 1 to about 15 carbon atoms, having from 0 to about 10 ester or ether groups, preferably 0 to about 5 such groups, along or in a chain or structure of the group. R⁵ may be a substituted or unsubstituted group. The substituted groups may include functional groups for providing other properties to the resulting polymer, provided they do not affect the dehalogenated organic polymer ultimately formed from the process and/or do not impact the reaction or rate thereof of the organic polymer having the halogen-containing reactive halogen group or negatively impact the reaction between such polymer with the alkali metal, such functional groups may include, for example, hydroxyl, carbonyl, ester, halide, mercapto and/or potassium.

Suitable alkali metal compounds include methyl lithium, methenyl lithium, ethyl lithium, ethenyl lithium, isoproypl lithium, propyl lithium, propenyl lithium, butyl lithium, isobutyl lithium, t-butyl lithium, s-butyl lithium, n-butyl lithium, butenyl lithium, and similar compounds, methyl sodium, methenyl sodium, ethyl sodium, ethenyl sodium, isopropyl sodium, propyl sodium, propenyl sodium, n-butyl sodium, s-butyl sodium, t-butyl sodium, butenyl sodium, and similar compounds, methyl potassium, methenyl potassium, ethyl potassium, ethenyl potassium, propenyl potassium, butyl potassium, isobutyl potassium, n-butyl potassium, s-butyl potassium, t-butyl potassium, butenyl potassium, and similar compounds, as well as, for example, benzyl lithium, phenyl lithium, benzyl sodium, phenyl sodium, benzyl potassium, phenyl potassium, and other related compound. Preferably, the alkali metal compound is butyl lithium, t-butyllithium, butyl sodium, t-butyl sodium, butyl potassium or t-butyl potassium.

The organic polymer having the at least one halogen-containing end group is reacted with the alkali metal compound preferably in a solvent environment. The solvent is preferably capable of dissolving the organic polymer having the at least one halogen-containing reactive group but free of functional groups that react with the halogen in the halogen-containing reactive group under the reaction conditions used. Suitable solvents include, but are not limited to heptane, hexane, tetrahydrofuran, and diphenyl ether as well as similar solvents and derivatives or functionalized variants of such solvents, with the most preferred solvent being tetrahydrofuran (THF).

The reaction preferably occurs at low temperatures of less than about −20° C., preferably less than about −50° C., and more preferably less than about −70° C. so as to minimize potential side reaction between the solvent used and the alkali metal compound. For example, as the half life of t-butyllithium in THF at −20° C. is about 42 minutes, by reacting it below that temperature, for example, at −70° C. to −78° C., further time is provided, as the estimated half life of that compound in THF is about 1,300 minutes. Thus the reaction proceeds as desired and reactive interference by thermal issues is minimized. The reaction preferably proceeds until a majority of halogen atoms are removed from the organic polymer, preferably substantially all of the halogen atoms, and most preferably virtually all or all of the halogen atoms are removed. Reaction times will vary depending on the solvent used, the alkali metal compound and the temperature of the reaction, but is expected to continue for about 0.5 to about 4 hours, and preferably about 1 to about 2 hours.

Before introducing the organic polymer to such a solvent reaction, it is preferred that the organic polymer having the at least one halogen-containing reactive group to be reacted in solvent with the alkali metal compound is first dried as a preparatory step before reacting the polymer with the alkali metal compound in the solvent. Such a drying step may be conducted in any suitable manner for the purpose of minimizing or removing adsorbed water from the polymer, as water may interfere with the reaction. One acceptable non-limiting method for drying the polymers is to oven-dry them in a vacuum oven at a temperature suitable for the polymer chosen. For a polyarylene polymer, temperatures of about 100° C. to about 200° C., more preferably about 110° C. to about 120° C. are suitable. Oven drying should occur until the polymer is at least substantially dry, and for approximately at least 10 hours, preferably at least 15 hours, and most preferably about 16 hours, with the understanding that drying times may also vary depending on the polymer and the level of adsorbed water in the pre-treated polymer. Drying can be verified via various types of moisture analysis, for example, Karl Fischer coulometric titration of the polymer dissolved in THF, measuring the dew point on an air dryer, or by loss of weight via thermogravimetric analysis (TGA) at temperatures less than about 250° C.

Once the dried organic polymer having the halogen-containing reactive group(s) is dissolved in the solvent and reacted with the alkali metal compound, an intermediate forms having a carbocation. This intermediate and the continuing reaction is then quenched by reacting the intermediate having the carbocation with acetic acid or a similar acetate group containing acid to form a dehalogenated organic polymer.

One reaction scheme for this reaction using a polyarylene polymer wherein the halogen-containing reactive group is diphenyl bromine, is shown in a reaction mechanism below:

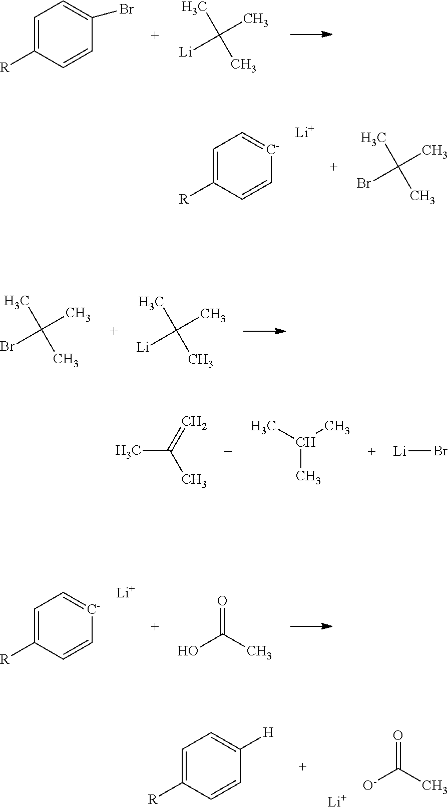

wherein R represents the polymer chain of formula (XX) including the first phenyl group in the terminal, diphenyl bromine group:

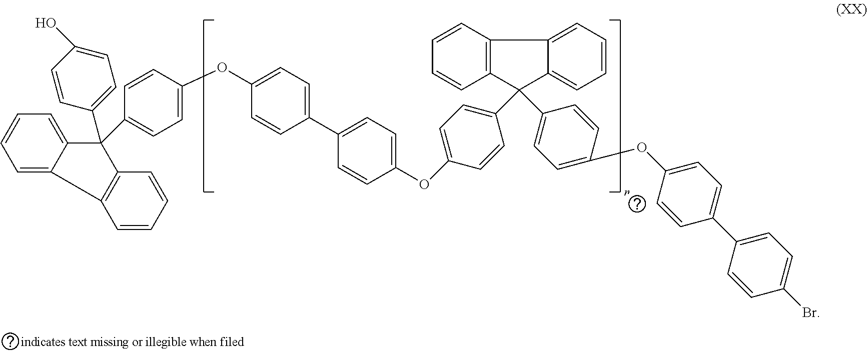

While the above mechanism shows a method for dehalogenation, other reactions and methods for removing halogen from such organic polymers may also be used. See, for example, J. Moon et al., “Hydrogenolysis of Aryl Halides by Hydrogen Gas and Hydrogen Transfer over Palladium-Supported Catalysts,” vol. 3, issue 6, Comptes Rendus L'Academie des Sciences—Chemistry, pp. 465-470 (November 2000). Dehalogenation may also be carried out via treatments with Grignard reagents. Grignard Degradation, Comprehensive Organic Name Reactions and Reagents, pp. 1271-1272 (September 2010).

After dehalogenation of the organic polymer is performed according to any of the various methods known in the art, the dehalogenated organic polymer can be introduced into a cross-linking reaction with a cross-linking compound of the present invention and will provide enhanced performance to such reaction. Any suitable graft, reaction, or similar cross-linking reaction may be used, wherein cross-linking occurs using a cross-linking compound according to one or more of formulas (I), (II), and (III), as discussed above.

Thus, an organic polymer composition may be formed including the dehalogenated organic polymer and a cross-linking compound according to formula (I), (II), or (III). A dehalogenated organic polymer having an aromatic group in the backbone, may be cross-linked using a cross-linking compound according to any of formulas (I), (II), and (III) as described above. One or more cross-linking compounds of the present invention are present in the cross-linking composition and may be combined with the dehalogenated organic polymers in such compositions.

The moiety A on the cross-linking compound may have any of the structures or features as discussed in detail above.

The cross-linking composition and the organic polymer composition also contain one or more cross-linking reaction additive(s) as rate-controlling compounds as discussed above. The cross-linking reaction additive(s) include organic acids and/or acetate compounds, which can promote oligomerization of the cross-linking compound. In other embodiments, inorganic acetate compounds, such as those having a structure according to formula (XII) may also be used instead of or in combination with the organic acids as discussed above. The cross-linking composition has the weight percentage ratio of the cross-linking compound to the cross-linking reaction additive as discussed above, and can be combined prior to addition of a dehalogenated organic polymer or simultaneously. Further, the weight percentage of cross-linking compound in the composition is the same as discussed above.

In making the organic polymer composition, it is preferred that the cross-linking compound and the cross-linking reaction additive components are combined prior to addition of a dehalogenated organic polymer to make an organic polymer composition. Alternatively, they may all be combined simultaneously.

The organic polymer composition may further be filled and/or reinforced and include one or more additives to improve the modulus, impact strength, dimensional stability, heat resistance and electrical properties of composites and other finished articles of manufacture formed using the polymer composition. These additive(s) can be any suitable or useful additives known in the art or to be developed, as described above.

In making the organic polymer composition, it is preferred that the additive(s) is/are added to the composition along with or at about the same time that the oligomerized cross-linking composition (or the combined components thereof) is combined with the dehalogenated organic polymer to make an organic polymer composition, however, the manner of providing reinforcing fibers or other fillers may be according to various techniques for incorporating such materials and should not be considered to limit the scope of the invention. The amount of additives is preferably about 0.5% by weight to about 65% by weight based on the weight of the organic polymer composition, and more preferably about 5.0% by weight to about 40% by weight.

In addition, the organic polymer composition may further comprise other compounding ingredients, including stabilizers, flame retardants as discussed above.

In an embodiment of the method of cross-linking according to the invention, after providing, for example by manufacturing, a cross-linking composition as described herein, the cross-linking composition is heated to induce oligomerization of the cross-linking compound.

In one embodiment of the method of cross-linking, the oligomerization occurs by acid catalysis. Acid catalysis is used when an organic acid is employed as the cross-linking additive. The R¹ functionality of the cross-linking compound of formula (I), (II), or (III) is dissociated from the remainder of the compound to afford a carbocation which then can undergo a Friedel-Crafts alkylation of the organic polymer, resulting in bond formation. In another embodiment of the method of the present invention, oligomerization of the cross-linking compound may occur by doping. Doping is accomplished by physically mixing solid form reactants in the composition at lower temperatures of about −100° C. to about −300° C. prior to reacting the overall composition for curing and/or heat molding the resulting composition to form an article.

The cross-linking method may further comprise adding the reacted oligomerized cross-linking composition to a debrominated organic polymer to form a cross-linkable composition. The unmodified cross-linking compound may be added directly to the dehalogenated organic polymer and blended with the cross-linking reaction additive to simultaneously oligomerize and bind to the dehalogenated organic polymer. Once the reactive oligomerized cross-linking compound reacts with the dehalogenated organic polymer, the rate of cross-linking of the dehalogenated organic polymer occurs at a later time in the curing process as compared to the rate of cross-linking that would occur in that organic polymer composition without dehalogenation treatment and using the same cross-linking system having the inhibitor additives as noted above or other prior art cross-linking systems. The result is the ability to more easily use traditional molding techniques and a controlled longer cross-linking time to form completely filled molds and excellent manufactured heat molded products.

Powders of the organic polymer compositions of the present invention can be made into pellets, and the pellets subjected to a heat molding process. Heat molding of the organic polymer compositions can be accomplished by many different means already known or to be developed in the art, including extrusion, injection molding, compression molding and/or injection/compression molding. Pellets of an organic polymer composition of the present invention may be injection molded, for example, on an Arbug® 38-ton injection molding machine with a cold runner system that includes a hot sprue.

Heat molding to form an article of manufacture may be accomplished by any method known or to be developed in the art as discussed above, and post-cure treatments may also be applied, if desired. The organic polymer compositions of the present invention may be cured by exposing the composition to temperatures greater than about 250° C. to about 500° C., and more preferably about 350° C. to about 450° C.

The compositions and/or the methods described above may be used in or to prepare articles of manufacture of down-hole tools and applications used in the petrochemical industry. Particularly, articles of manufacture may be one or more of acid-resistant coatings, chemical-casted films, extruded films, solvent-casted films, blown films, encapsulated products, insulation, packaging, composite cells, connectors, and sealing assemblies in the shape of O-rings, V-rings, U-cups, gaskets, bearings, valve seats, adapters, wiper rings, chevron back-up rings, and tubing as discussed above.

The Applicants have also determined that as was the case with Applicant's previously invented cross-linking compounds as described in U.S. Pat. No. 9,109,075, incorporated herein by reference in relevant part, the cross-linked aromatic polymers formed using the new cross-linking compounds of the present invention while non-elastomeric at room temperature, and in particular, classes of cross-linked polyarylene polymers or polyphenylene sulfides, when applied in use in end applications above the glass transition temperature of the cross-linked aromatic polymer, become elastomeric in nature while maintaining excellent mechanical properties. Such materials can thus be used in harsh conditions and high-temperature applications including conditions where FFKM materials can experience degradation. Because materials used herein can be cross-linked without complex synthesis, the cross-link density can be controlled for differing end applications. The materials have high temperature stability while maintaining good mechanical properties in use. Thermal stability derives from the backbone thus providing an advantage against thermal degradation over traditional FFKMs in high temperature end applications.

As used herein, “high temperature” applications include, within the context of the organic polymer being used, end applications requiring temperatures of about 30° C. above the T_{g} of the organic polymer subjected to the end applications, and in preferred embodiments using polyarylene polymers and similar high temperature polymers, encompasses those applications at temperatures at which traditional FFKMs may experience thermal degradation, such as temperatures of about 330° C., and preferably about 340° C. or higher. “High T_{g}” materials include those materials having a T_{g} of about 150° C. or more, and “low T_{g}” materials include those materials having a T_{g} of less than about 150° C. One skilled in the art would understand, based on this disclosure, that the temperature divide between “high T_{g}” and “low T_{g}” materials may be gradual, and that materials at varying T_{g} levels may benefit from the invention herein.

Methods of preparing an elastomeric material are included herein. In one embodiment, in a first step, an aromatic polymer is provided which is nonelastomeric at room temperature. By “nonelastomeric” is meant materials which are not elastomeric in behavior at room temperature or under standard conditions.

“Elastomers” or “elastomeric” as those terms are used herein refer to polymers which are amorphous above the glass transition temperature of the polymer allowing for flexibility and deformability, and which upon deformation can recover their state to a large degree. The elastomers or elastomeric materials herein are formed as cross-linked chains, wherein the cross-linkages enable the elastomer to significantly recover its original configuration when an applied stress is removed, instead of being permanently deformed.

Many elastomeric materials are evaluated not only by measuring mechanical properties, such as tensile strength, flexural strength, elongation and modulus, but also by evaluating the ability of the material to recover after deformation. One property that is evaluated in this context is compression set resistance. As used herein, “compression set” refers to the propensity of an elastomeric material to remain distorted and not return to its original shape after a deforming compressive load has been removed. The compression set value is expressed as a percentage of the original deflection that the material fails to recover. For example, a compression set value of 0% indicates that a material completely returns to its original shape after removal of a deforming compressive load. Conversely, a compression set value of 100% indicates that a material does not recover at all from an applied deforming compressive load. A compression set value of 30% signifies that 70% of the original deflection has been recovered. Higher compression set values generally indicate a potential for seal leakage and so compression set values of 30% or less are preferred in the sealing arts.

The aromatic polymers herein that are nonelastomeric at room temperature include preferably polyarylene polymers. A single organic polymer maybe cross-linked or more than one type of such an organic polymer may be cross-linked at the same time, preferably by first combining the polymers and then reacting the combined polymers with a cross-linking compound or thermally inducing cross-linking in organic polymers having a graft on the polymer backbone as described further below.

The at least one organic polymer may be one of a number of higher glass transition temperature organic polymers used alone or in combination, such as, but not limited to poly(arylene ether)s, polysulfones, polyethersulfones, polyarylene sulfides, polyimides, polyamides, polyureas, polyurethanes, polyphthalamides, polyamide-imides, poly(benzimidazole)s, polyarylates, liquid crstalline polymers (LCPs) and polyaramids. Preferably, if being subjected to a reaction with a cross-linking compound, the polymers are non-functionalized, i.e., they are chemically inert and they do not bear any functional groups that could be detrimental to their use in downhole tool articles of manufacture or other demanding end applications.

Preferably, the organic polymer is a poly(arylene ether) of formula (XIII) as discussed above. More preferably, the organic polymer is of a structure according to formula (XIV), also discussed above.

In addition, polymers formed from thermally induced cross-linking of a polyarylene backbone having at least one graft thereon within the scope of the invention. Such materials are described in U.S. Pat. No. 6,060,170, which is incorporated herein by reference with respect to its description of the formation of such polymers and resulting end products. The organic polymer may also be cross-linked by use of a cross-linking compound either directly as in U.S. Pat. No. 9,006,353 or reacting also with a cross-linking reaction additive as described further herein.

Suitable cross-linked polyarylene organic polymers for use in the invention may be obtained commercially for example, as the high temperature polymer, Ultura™ from Greene, Tweed and Co., Inc., Kulpsville, Pa.

The cross-linking compounds may be used as only a single compound or a combination of two or more such cross-linking compounds. They may be combined to form a cross-linking composition herein with the organic polymers noted above. The cross-linking compound has a structure according to one or more of formula (I), formula (II), and formula (III), and is of the type discussed above. The A moiety may be varied and may be functionalized as discussed above, and A is preferably a bond.

Preferred organic polymers including commercial materials such as Ultura™ as noted above, polyetherether ketone, high-temperature polyetherether ketone, cross-linkable grafted polyarylene ethers, 1,4-polyarylene ethers and similar polymers. Amorphous polyarylenes such as amorphous polyetherether ketone in meta and ortho orientations can be used to provide elastomeric properties at even lower temperatures, e.g., about 150° C. to about 160° C., if desired. A 1,4-polyarylene ether can be used to obtain lower glass transition temperatures in the range of about 100° C. Polyphenylene sulfide can also be used for similar glass transition temperatures.

Examples of various 1,4-polyetherether ketones in different orientations are shown below:

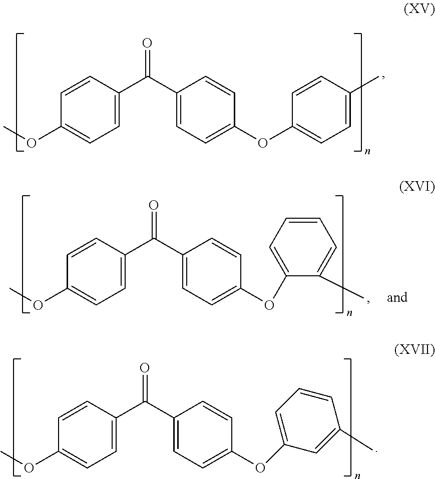

The top structure (XV) above represents a commercially available polyetherether ketone formed using para-hydroquinone monomer. The middle (XVI) and bottom (XVII) structures above represent ortho-PEEK and meta-PEEK, respectively. A high temperature commercial polyarylene ether organic polymer preferred for use herein is shown below as well:

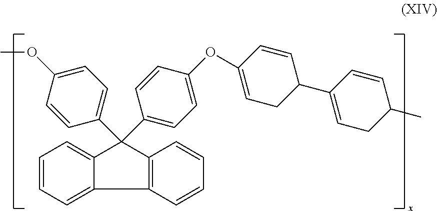

Applications for low T_{g} materials, i.e., those materials having a T_{g} of less than about 150° C., in which such materials can be put into use as elastomeric materials and benefit from the invention in higher temperature applications are preferably those end applications having a temperature about 30° C. or more greater than the low T_{g} material's T_{g}. Similarly, applications for high T_{g} materials, i.e., those materials having a T_{g} of about 150° C. or more, in which such materials may be put into use as elastomeric materials and benefit from the invention in higher temperature applications are preferably those end applications having a temperature of about 30° C. or more greater than the high T_{g} material's T_{g}.

In low T_{g} applications, a polyarylene ether, such as in a 1,4-polyarylene ether is shown below (XVIII), which has a T_{g} of about 90° C. Polyphenylene sulfide has a similar structure (XIX) and glass transition temperature as polyarylene ether, so both yield similar elastomeric properties. However, because the thioether bond is less resistant to oxidation than an ether bond as in the polyarylene ether, for highly oxidizing environments polyphenylene ether would be a preferred base polymer for an oxidation resistant elastomeric composition.

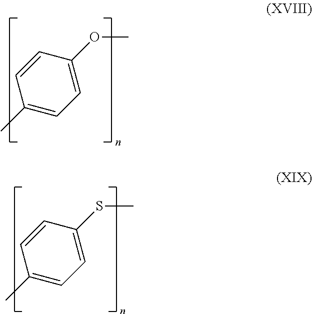

The cross-linking composition and organic polymer composition also contain a cross-linking reaction additive as discussed above. The cross linking reaction additives include organic acids and/or acetate compounds, preferably acetate compounds having the structure of formula (XII) as discussed above.

An oligomerization reaction using one of the cross-linking compounds can occur as discussed above. The cross-linking composition can have the weight percentage ratio as discussed above, and the organic polymer composition can have the same weight percentage ratio as discussed above. It is preferred the cross-linking compound and cross-linking reaction additive are combined prior to addition of an organic polymer to make an organic polymer composition as discussed above, or they may be combined simultaneously. The organic polymer composition may be filled or reinforced by one or more additives as discussed above. The organic polymer composition may further include other compounding ingredients, such as stabilizers, flame retardants, among others as discussed above.

It is also optionally within the scope of the invention to add a reacted oligomerized cross-linking composition to an organic polymer to form a cross-linkable composition. The unmodified cross-linking compound may be added directly to the organic polymer and blended with the cross-linking reaction additive to simultaneously oligomerize and bind to the organic polymer. Once the reactive oligomerized cross-linking compound reacts with the organic polymer, use of a cross-linking reaction additive if employed assists in controlling the rate of cross-linking of the organic polymer for certain aromatic polymers, particularly for polyarylene ethers. The result is complete filling of the mold and a more excellent end heat molded/extruded, etc. product formed from the composite polymer during various heat molding techniques.

The compound is thus cross-linked as noted above to form a cross-linked aromatic polymer, which may be filled or unfilled.

The cross-linked aromatic polymer is preferably heated to a temperature at or above the glass transition temperature of the cross-linked aromatic polymer. This temperature may vary according to the nature of the cross-linked organic polymer. For the preferred polyarylene polymers, the glass transition temperature is about 80° C. to about 350° C., and more preferably about 100° C. to about 280° C. The heating may be done deliberately or occur through application of heat in the end use application, which may be a high temperature application, however, it is preferred that cross-linking be substantially done, that is, the material be substantially cured, or more preferably complete before use in a high temperature end application. As used herein, “substantially cured” means cured to a degree where employing the material in its end application will not impact its potential elastomeric properties, and is preferably at least about 80%, more preferably at least about 90% and most preferably as fully cured as possible up to 100% cured.

It is further preferred that after forming a composition having the cross-linked organic polymer therein, that the composition be heated to form a molded article. Heat molding to form an article of manufacture may be accomplished by any method known or to be developed in the art as discussed above. Post-cure treatments may also be applied, if desired. The organic polymer compositions of the present invention are cured by exposing the composition to temperatures greater than about 250° C. to about 500° C., and more preferably about 350° C. to about 450° C.

The composition and methods described may be used to prepare articles of manufacture for use in downhole tools and applications used in the petrochemical industry as discussed above.

In the end use, the end application of use temperature at or above the glass transition temperature of the cross-linked organic polymer, which will vary depending on the material used. The cross-linked organic polymers herein have glass transition temperature of about 80° C. to about 300° C. for cross-linked polyarylenes, about 180° C. to about 360° C. for cross-linked polysulfones, about 200° C. to about 290° C. for polyethersulfones, about 200° C. to about 380° C. for polyimides, about 40° C. to about 100° C. polyamides, about −50° C. to about 260° C. for polyureas, about −65° C. to about 100° C. for polyurethanes, about 80° C. to about 130° C. for polyphthalamides, about 200° C. to about 280° C. for polyamide-imides, about 180° C. to about 300° C. for poly(benzimidazole)s, about 180° C. to about 380° C. for polyarylates, about 50° C. to about 160° C. for LCPs, and about 170° C. to about 250° C. for polyaramids.

The information provided above may be used in a variety of further embodiments as noted below, wherein each component may be as described in detail above. An elastomeric material may be formed, for example, by heating a cross-linked aromatic polymer at or above its glass transition temperature. In this embodiment, the aromatic polymer is cross-linked by reaction with the cross-linking compound of the present application and/or reactive cross-linking additive or is cross-linked by thermally induced cross-linking of an aromatic polymer having a graft bonded to the aromatic polymer.

Elastomeric articles as noted above may also be formed by heat molding compositions as described above including the cross-linked aromatic polymer to form molded articles and heating the molded articles at or above a glass transition temperature of the cross-linked aromatic polymer. The aromatic polymers are cross-linked by reaction with the cross-linking compounds of the present invention and/or reactive cross-linking additives as noted above or by the thermally induced cross-linking of an aromatic polymer having a graft bonded to the aromatic polymer.

An elastomeric material may be formed by providing an aromatic polymer that is nonelastomeric at room temperature; and combining it with a cross-linking compound of the present invention and/or a cross-linking reaction additive. The cross-linking compound and any cross-linking reaction additive (whether added independently or formed into an oligomer) are then combined with the aromatic polymer form a cross-linked aromatic polymer that becomes elastomeric when heated at or above its glass transition temperature.

Also within the invention is an embodiment including a method of using an organic polymer in an elastomeric application. The organic polymer is cross-linked using a cross-linking compound of the present application to form a cross-linked organic polymer but can be prepared using the thermally induced graft technique of U.S. Pat. No. 6,060,170. The cross-linked polymer is then heated in use at or above a glass transition temperature such that it becomes elastomeric. The cross-linked organic polymer may also be molded into a molded article, which is then placed in use and so that it is subjected to heat that applies to the molded article while in use in a high temperature end application so as to heat the cross-linked polymer at or above the glass transition temperature rendering the material elastomeric.

In another embodiment of the present application, Applicants describe compositions and methods herein that are suitable for making sealing components, seal connectors and the like that resist creep and extrusion and maintain good mechanical properties at high continuous use temperatures and in end uses requiring good chemical resistance as well. Applicant previously disclosed compositions and methods for making sealing components that resist creep and extrusion in U.S. Pat. No. 9,127,138. Such compositions were limited to specific cross-linking compounds that may be difficult and/or expensive to produce. Thus, the present invention provides compositions and methods for making sealing components that resist creep and extrusion utilizing a wider variety of cross-linking compounds that are more readily produced and that can be more cheaply produced.

The compositions described herein include the cross-linking compounds of the present invention and are extrusion-resistant and creep-resistant, while maintaining good sealing and ductility properties. The compositions are useful for forming sealing members or sealing connectors and similar components used in harsh and/or high temperature conditions. As used herein, a “high temperature” environment is meant in its ordinary meaning, and one skilled in the art would know that high temperature environments include those in which service temperatures are at or above the glass transition temperature of the polymer in service. Concerning the polymers discussed below, such high temperature environments are typically those over 177° C. (350° F.).

The compositions include an aromatic polymer and a cross-linking compound having a structure of formula (I), formula (II), and formula (III) as discussed above and may further include optional cross-linking reaction additives if desired. Upon cross-linking the compositions, a component may be formed having the desired high-temperature properties. The cross-linking reactions herein raise the glass transition temperature of the resulting product such that in use, it functions better and resists extrusion. The improvement of the properties allows for use of unfilled compositions in high temperature and/or harsh conditions such as downhole environments. This is a significant advantage in that the user can avoid having to fill the compound to achieve desired mechanical properties in use and to help resist creep. Instead, the user is able to maintain good mechanical properties, resist creep and extrusion while keeping the desired sealing ductility and tensile elongation that make sealing components function well in the gland.

The polymer used herein may be one or more of aromatic polymers known and/or selected for high temperature or creep-resistant use, including polyarylene polymers, polysulfones, polyphenylenesulfides, polyimides, polyamides, polyureas, polyurethanes, polyphthalamides, polyamide-imides, aramids, polybenzimidazoles, and blends, copolymers and derivatives thereof. Preferably, the aromatic polymer is a polyarylene polymer and/or a polysulfone polymer, and blends, copolymers and derivatives thereof. If the aromatic polymer is a polyarylene-type polymer, it is preferably at least one of polyetheretherketone (PEEK), polyetherketone (PEK), polyetherketoneetherketoneketone (PEKEKK), polyetherketoneketone (PEKK), polysulfone (PSU), polyethersulfone (PES), polyarylsulfone (PAS), and blends, copolymers and derivatives thereof.

When the aromatic polymer is a polyarylene ether polymer, it may have repeating units of structure according to the structure of formula (XIII) as discussed above. In one preferred embodiment, the organic polymer is a polyarylene ether having a structure according to formula (XIV) above.

The cross-linking compound(s) if used with additives can be reacted to form a reactive oligomerized cross-linking intermediate as discussed above. Utilization of one or more cross-linking reaction additive(s) can assist in providing polymers with even higher glass transition temperatures and higher cross-link density as discussed above.

The cross-linking composition and the organic polymer composition may also contain an optional cross-linking reaction additive. The cross-linking reaction additive(s) include organic acids and/or acetate compounds, which can promote oligomerization of the cross-linking compound as discussed in further detail above. The oligomerization can proceed by the reactions discussed and shown above. The cross-linking composition has the weight percentage ratios of cross-linking compound to cross-linking reaction additive as discussed above. Further, the organic polymer composition has a weight percentage ratio of organic polymer to weight of the cross-linking compound as discussed above.

It is preferred that the extrusion-resistant and creep-resistant compositions herein remain unfilled, particularly with respect to strength additives that may impact ductility and tensile elongation. However, it is also within the scope of the invention that the organic polymer composition may further be filled and/or reinforced and include one or more additives as described above in order to improve the modulus, impact strength, dimensional stability, heat resistance and electrical properties of composites and other finished articles of manufacture formed using the polymer composition.

In making the organic polymer composition, it is preferred that the additive(s) is/are added to the composition along with or at about the same time that the cross-linking compound is combined with the organic polymer to make an organic polymer composition as discussed above.

In addition, the organic polymer composition may further comprise other compounding ingredients (e.g., plasticizers, stabilizers) as discussed above.

Heat molding to form an article of manufacture may be accomplished by any method known or to be developed in the art as discussed above.

The compositions and/or the methods described above may be used in or to prepare articles of manufacture of downhole tools and applications used in the petrochemical industry. Particularly, the article of manufacture is selected from the group consisting of acid-resistant coatings, chemical-casted films, extruded films, solvent-casted films, blown films, encapsulated products, insulation, packaging, composite cells, sealing connectors, and sealing assemblies having back-up rings, packer elements, labyrinth seals for pumps and MSE® seals (available from Greene, Tweed & Co., Inc. of Kulpsville) having a dual-lip design, and other antiextrusion and anti-creep components in the shape of O-rings, V-rings, U-cups, gaskets, bearings, valve seats, adapters, wiper rings, chevron back-up rings, and tubing.

The invention also includes sealing components of a sealing assembly formed by a method comprising the step of cross-linking a composition as described herein. A sealing connector is also included herein having a seal connector body formed by a method comprising the step of cross-linking a composition as described herein.

The invention further includes a method of improving extrusion- and creep-resistance of a component for use in a high temperature sealing element or seal connector, comprising, providing a composition comprising an aromatic polymer and a cross-linking compound of a structure selected from formula (I), formula (II), and formula (III) and subjecting the composition to a heat molding process to form the component and cross-link the aromatic polymer as described above. The composition is preferably unfilled. The aromatic polymer and cross-linking compound may be any of those noted herein and described above, and the composition may also include the optional cross-linking reaction additive.

### EXAMPLES

### Example 1—Sample Preparation

A blend of a cross-linking compound of the present invention along with an organic polymer, and a cross-linking additive was prepared in a freeze mill. The blend was in the form of a powder and consisted of 3.4 grams of a cross-linking compound according to the present invention of formula:

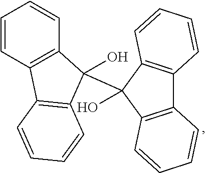 [SMILES: OC1(C2(O)c3ccccc3-c3ccccc32)c2ccccc2-c2ccccc21]

16.6 grams of PEEK (Vestakeep 5000FP), and 0.02 grams of the cross-linking additive, lithium acetate dihydrate. A comparative sample comprising only the polymer, PEEK (Vestakeep 5000FP) was also prepared. The inventive blend and comparative sample were analyzed using Differential Scanning calorimetry (DSC) and parallel plate rheology to detect the presence of cross-link formation in the polymer. These DSC and parallel plate rheology clearly indicated that the inventive blend was able to induce thermal crosslinking.

### Example 2—Differential Scanning Calorimetry

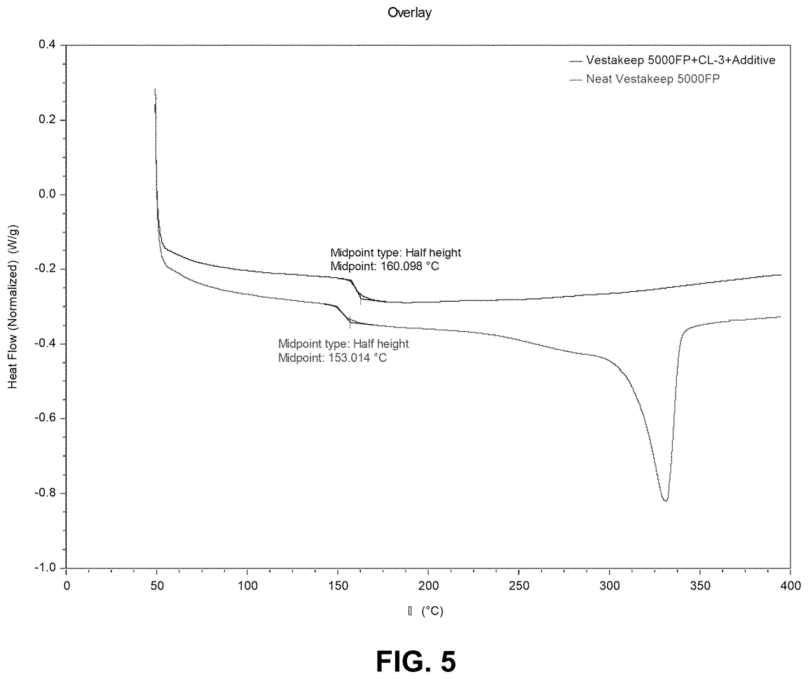

The inventive blend and the comparative sample of Example 1 were analyzed to study cross-linking. The inventive blend and the comparative sample were each heated during a first heating step at a rate of 20° C./minute to a temperature of 500° C. Once heated, the samples were cooled at a rate of 5° C./minute to a temperature of 40° C. The samples were then heated during a second heating step at a rate of 20° C./minute to 400° C. The resultant graph of the heat flow at each temperature during the second heating step is shown at FIG. 5. The glass transition temperature of the comparative sample of PEEK showed a glass transition temperature of 153° C. The second heating step for the inventive blend showed a glass transition temperature of 160° C. The higher glass transition temperature of the inventive blend including PEEK relative to the comparative sample of PEEK alone, provides a strong indication that the inventive blend underwent crosslinking in the DSC cell.

### Example 3—Rheology

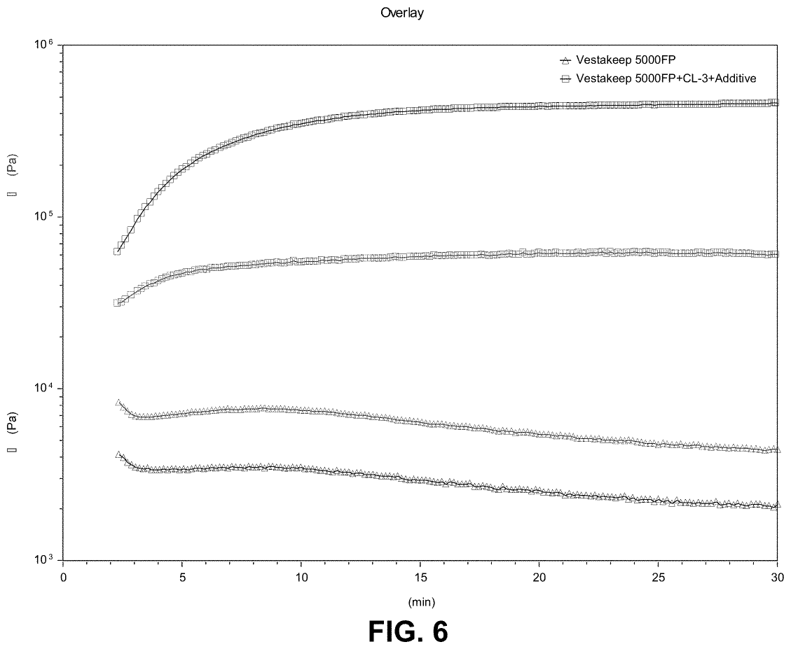

The samples of Example 1 were also studied using an oscillation rheometer. Strain oscillation was applied with parallel plate geometry on tablets of the inventive blend and of the comparative sample. The rheology experiments were run under nitrogen atmosphere and an isothermal temperature of 380° C. with 0.1% applied strain and 1 Hz frequency. The instrument was heated to 380° C. and then a sample was introduced. After sample insertion, the temperature was maintained at 380° C. and the storage modulus (G′) and loss modulus (G″) were recorded for thirty minutes. The storage modulus represents the solid response of the material, and the loss modulus represents viscous behavior. Thus, when G′ is less than G″, the material is in a viscous, liquid state, whereas when G′ is greater than G″, the material is above the gel point and is solid. When a polymer is cross-linked, the material transitions from a liquid state to a solid state, wherein G′ is greater than G″. Referring now to FIG. 6, there is shown the resulting rheology time sweep at 380° C. for the comparative sample and the inventive blend. For the comparative sample, the loss modulus (G″) is always greater than the storage modulus (G′), indicating that the comparative sample did not undergo crosslinking at 380° C. and was in a fluid state as a polymer melt, which is typical for a thermoplastic material. In contrast, the inventive blend showed a storage modulus (G′) that is always higher than the loss modulus (G″). This indicates that the inventive blend rapidly underwent crosslinking at 380° C. and was in a solid state.

1. A cross-linking composition comprising a cross-linking compound for cross-linking an organic polymer, wherein the cross-linking compound is selected from the group consisting of: 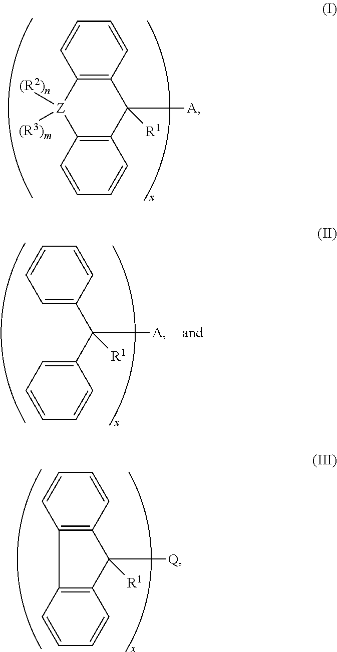
wherein Q is a bond, wherein A is Q, an alkyl, an aryl, or an arene moiety having a molecular weight less than about 10,000 g/mol wherein each of R¹, R², and R³ has a molecular weight less than about 10,000 g/mol, wherein R¹, R², and R³ are the same or different and selected from the group consisting of hydrogen, hydroxyl (—OH), amine (—NH₂), halide, ether, ester, amide, aryl, arene, or a branched or straight chain, saturated or unsaturated alkyl group of one to about six carbon atoms, wherein m is from 0 to 2, n is from 0 to 2, and m+n is greater than or equal to zero and less than or equal to two, wherein Z is selected from the group of oxygen, sulfur, nitrogen, and a branched or straight chain, saturated or unsaturated alkyl group of one to about six carbon atoms, and wherein x is about 1.0 to about 6.0.

2. The cross-linking composition according to claim 1, wherein the cross-linking compound has a structure according to formula (I) and is selected from a group consisting of

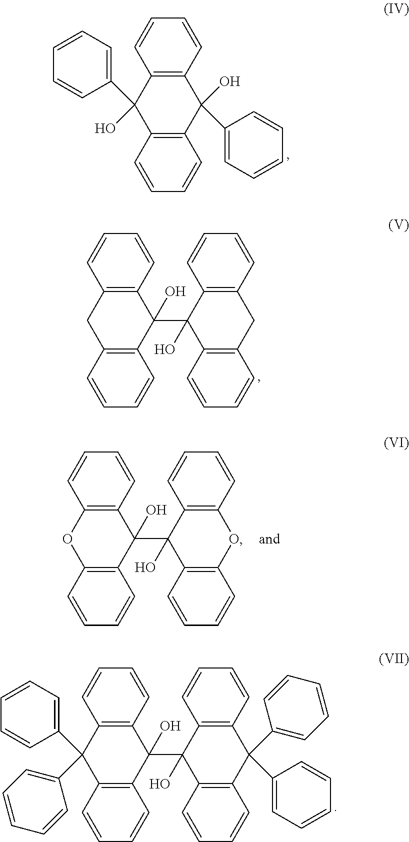

3. The cross-linking composition according to claim 1, wherein the cross-linking compound has a structure according to formula (II) and is selected from the group consisting of:

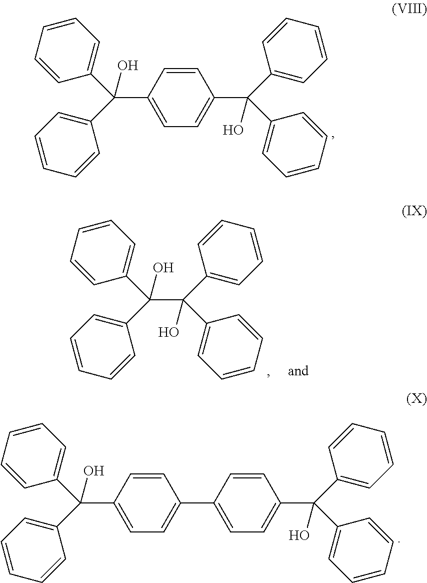 [SMILES: OC(c1ccccc1)(c1ccccc1)c1ccc(C(O)(c2ccccc2)c2ccccc2)cc1 ; OC(c1ccccc1)(c1ccccc1)C(O)(c1ccccc1)c1ccccc1 ; OC(c1ccccc1)(c1ccccc1)c1ccc(-c2ccc(C(O)(c3ccccc3)c3ccccc3)cc2)cc1]

4. The cross-linking composition according to claim 1, wherein the cross-linking compound has a structure according to formula (III) and also as follows:

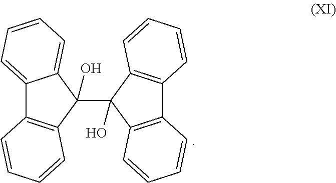 [SMILES: OC1(C2(O)c3ccccc3-c3ccccc32)c2ccccc2-c2ccccc21]

5. The cross-linking composition according to claim 1, wherein A has a molecular weight of about 1,000 g/mol to about 9,000 g/mol.

6. The cross-linking composition according to claim 1, further comprising at least one organic polymer selected from poly(arylene ether)s, polysulfones, polyethersulfones, polyimides, polyamides, polyureas, polyurethanes, polyphthalamides, polyamide-imides, poly(benzimidazole)s, and polyaramids.

7. The cross-linking composition according to claim 6, wherein the organic polymer is a poly(arylene ether) including polymer repeating units having the following structure: 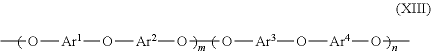
wherein Ar¹, Ar², Ar³ and Ar⁴ are identical or different aryl radicals, m=0 to 1.0, and n=1-m.

8. The cross-linking composition according to claim 7, Wherein the organic polymer is a poly(arylene ether), in is 1 and n is 0 and the polymer has repeating units having the structure of formula (XIV):

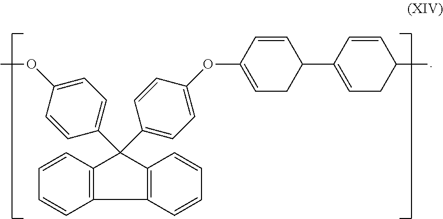

9. The cross-linking composition according to claim 6, wherein the cross-linking composition further comprises at least one additive selected from continuous or discontinuous, long or short, reinforcing fibers selected from carbon fibers, glass fibers, woven glass fibers, woven carbon fibers, aramid fibers, boron fibers, polytetraffuorethylene fibers, ceramic fibers, polyamide fibers; and one or more fillers selected from carbon black, silicate, fiberglass, calcium sulfate, boron, ceramic, polyamide, asbestos, fluorographite, aluminum hydroxide, barium sulfate, calcium carbonate, magnesium carbonate, silica, alumina, aluminum nitride, borax (sodium borate), activated carbon, pearlite, zinc terephthalate, graphite, talc, mica, silicon carbide whiskers or platelets, nanofillers, molybdenum disulfide, fluoropolymer, carbon nanotubes and fullerene tubes.

10. The cross-linking composition according to claim 9, wherein the cross-linking composition comprises about 0.5% to about 65% by weight of the at least one additive.

11. The cross-linking composition according to claim 1, further comprising a cross-linking reaction additive selected from an organic acid and/or an acetate compound, wherein the cross-linking reaction additive is capable of reacting with the cross-linking compound to form a reactive intermediate in the form of an oligomer, which reactive intermediate oligomer is capable of cross-linking an organic polymer.

12. The cross-linking composition according to claim 11, wherein the cross-linking reaction additive is an organic acid selected from glacial acetic acid, formic acid, and/or benzoic acid.

13. The cross-linking composition according to claim 11, wherein the cross-linking reaction additive is an acetate compound having a structure according to formula (XII): 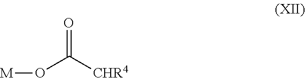
wherein M is a Group I or a Group II metal; and R⁴ is an alkyl, aryl or aralkyl group, wherein the alkyl group comprises a hydrocarbon group of 1 to about 30 carbon atoms which has from 0 to about 10 ester or ether groups along or in a chain or structure of the group, and wherein R⁴ comprises 0 to about 10 functional groups selected from sulfate, phosphate, hydroxyl, carbonyl, ester, halide, mercapto or potassium.

14. The cross-linking composition according to claim 13, wherein the acetate compound is selected from lithium acetate hydrate, sodium acetate, and/or potassium acetate, and salts and derivatives thereof.

15. The cross-linking composition according to claim 11, wherein the weight percentage ratio of the cross-linking compound to the cross-linking reaction additive is about 10:1 to about 10,000:1.

16. The cross-linking composition according to claim 11, further comprising at least one organic polymer, wherein the cross-linking reaction additive is capable of reacting with the cross-linking compound to form a reactive intermediate in the form of an oligomer, which reactive intermediate oligomer is capable of cross-linking the organic polymer.

17. The cross-linking composition according to claim 16, wherein the weight percentage ratio of the organic polymer to the combined weight of the cross-linking compound and the cross-linking reaction additive is about 1:1 to about 100:1.

18. The cross-linking composition according to claim 16, wherein the organic polymer is selected from poly(arylene ether)s, polysulfones, polyethersulfones, polyimides, polyamides, polyureas, polyurethanes, polyphthalamides, polyamide-imides, poly(benzimidazole)s, and polyaramids.

19. The cross-linking composition according to claim 18, wherein the organic polymer is a poly(arylene ether) including polymer repeating units having the following structure: 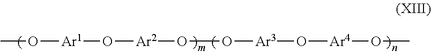
wherein Ar¹, Ar², Ar³ and Ar⁴ are identical or different aryl radicals, m=0 to 1.0, and n=1-m.

20. The cross-linking composition according to claim 19, wherein the organic polymer is a poly(arylene ether), m is 1 and n is 0 and the polymer has repeating units having the structure of formula (XIV):

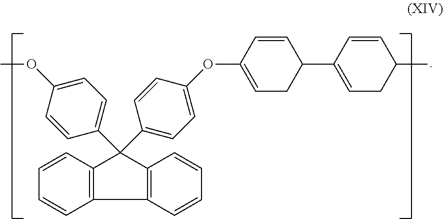

21. The cross-linking composition according to claim 16, wherein the cross-linking composition further comprises at least one additive selected from continuous or discontinuous, long or short, reinforcing fibers selected from carbon fibers, glass fibers, woven glass fibers, woven carbon fibers, aramid fibers, boron fibers, polytetrafluorethylene fibers, ceramic fibers, polyamide fibers; and one or more fillers selected from carbon black, silicate, fiberglass, calcium sulfate, boron, ceramic, polyamide, asbestos, fitiorographite, aluminum hydroxide, barium sulfate, calcium carbonate, magnesium carbonate, silica, alumina, aluminum nitride, borax (sodium borate), activated carbon, pearlite, zinc terephthalate, graphite, talc, mica, silicon carbide whiskers or platelets, nanofillers, molybdenum disulfide, fluoropolymer, carbon nanotubes and fullerene tubes.

22. The cross-linking composition according to claim 21, wherein the cross-linking composition comprises about 0.5% to about 65% by weight of the at least one additive.

23. The cross-linking composition according to claim 16, wherein the cross-linking composition further comprises one or more of a stabilizer, a flame retardant, a pigment, a plasticizer, a surfactant, and a dispersant.

24. A molded article formed from the cross-linking composition according to claim 16.

25. The molded article according to claim 24, wherein the molded article is molded using extrusion, injection molding, blow molding, blown film molding, compression molding, or injection/compression molding.

26. An article of manufacture formed from the composition according to claim 16, wherein the article of manufacture is selected from acid-resistant coatings, chemical-casted films, extruded films, solvent-casted films, blown films, encapsulated products, insulation, packaging, composite cells, connectors, and sealing assemblies in the shape of O-rings, V-rings, U-cups, gaskets, bearings, valve seats, adapters, wiper rings, chevron back-up rings, and tubing.

27. A method of controlling, the cross-linking reaction rate of a cross-linking compound for use in cross-linking an organic polymer, comprising:
(a) providing the cross-linking composition according to claim 1;
(b) heating the cross-linking composition such that oligoinerization of the cross-linking compound occurs.

28. The method according to claim 27, wherein the cross-linking composition further comprises one or more additional cross-linking compounds.

29. The method according to claim 27, wherein step (h) further comprises heating the cross-linking composition before heat molding.

30. The method according to claim 27, wherein the cross-linking reaction additive is an organic acid selected from glacial acetic acid, formic acid and/or benzoic acid and/or an acetate compound selected from lithium acetate hydrate, sodium acetate, and/or potassium acetate, and salts and derivatives thereof.

31. The method according to claim 27, further comprising combining the cross-linking compound and the cross-linking reaction additive in a solvent in step (a) and reacting the cross-linking compound and the cross-linking reaction additive to form a reactive oligomerized cross-linking compound.

32. The method according to claim 31, further comprising:
(c) adding the reactive oligomerized cross-linking compound to an organic polymer to form a cross-linkable composition, and
(d) cross-linking the organic polymer composition to firm a cross-linked organic polymer.

33. The method according to claim 32, wherein the organic polymer is selected from poly(arylene ether)s, polysulfones, polyethersulfones, polyimides, polyamides, polyureas, polyurethanes, polyphthalamides, polyamide-imides, poly(benzimidazole)s and/or polyaramids.

34. The method according to claim 33, Wherein the organic polymer is a poly(arylene ether) including polymer repeating units having the following structure: 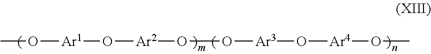
wherein Ar¹, Ar², Ar³ and Ar⁴ are identical or different aryl radicals, m=0 to 1.0, n=1-m.

35.-72. (canceled)

73. A method of improving extrusion- and creep-resistance of a component for use in a high temperature sealing element or seal connector, comprising,
providing a composition comprising an aromatic polymer and a cross-linking compound according to claim 1,
subjecting the composition to a heat molding process to form the component and cross-link the aromatic polymer.

74. The method according to claim 73, wherein the composition is unfilled.

75. The method according to claim 73, wherein the aromatic polymer is selected from the group consisting of a polyarylene polymer, a polysulfone, a polyphenylenc sulfide, a polyimide, a polyamide, a polyurea, a polyurethane, a polyphthalamide, a polyamide-imide, tare aramid, a polybenzimidazole, and blends, copolymers and derivatives thereof.

76. A scaling component formed by the method of claim 73.

77. The sealing component according to claim 76, wherein the composition is unfilled.
